(19) United States
(12) Patent Application Publication
(10) Pub. No.: US 2014/0105508 A1
(43) Pub. Date: Apr. 17, 2014

(54) Systems and Methods for Intelligent Purchase Crawling and Retail Exploration

(71) Applicant: Aditya Arora, Pleasanton, CA (US)

(72) Inventor: Aditya Arora, Pleasanton, CA (US)

(21) Appl. No.: 13/651,316

(22) Filed: Oct. 12, 2012

(51) Int. Cl. G06K 9/68

(52) U.S. Cl. 382/218

(57) ABSTRACT

A method may comprise identifying a field of a digital document as containing information related to an order. The method may include deconstructing the field into a character string. The method may include comparing the character string with a set of regularized purchase-related expressions, thereby parsing the character string. The method may include extracting order information from the character string if the character string meets a condition of the one regularized purchase-related expression, and providing the extracted order information. Also disclosed are related systems.

### TECHNICAL FIELD

The technical field relates to computer systems and methods. More particularly, the technical field relates to computer systems and methods for data organization and exploration.

### BACKGROUND

The retail industry has long been important to the lifeblood of the national and global economies. For decades, consumer demand for retail items has driven economic upturns and downturns, and has provided a measure of global economic health. Consumer demand has also driven innovation across a diverse array of technological sectors as designers and manufacturers have struggled to develop the trillions of dollars of items being purchased every year. The growth of wired and wireless data networks alike has made retail purchasing more efficient. The expansion of data networks has provided customers with the ability to find and purchase items anywhere they have a data connection.

An electronic commerce revolution has sprung from the nexus of consumer demand and the widespread data network infrastructure. Exclusively online retailers like have managed to sell billions of dollars of retail items internationally without physical stores. Entire industries, such as large-scale brick-and-mortar bookstores, have been brought to their knees. To remain competitive, traditional brick-and-mortar retailers have labored to create a competitive online presence. In many areas and during high-season shopping times such as holiday shopping seasons, online shopping often outpaces shopping at brick-and-mortar stores.

The electronic commerce revolution may present problems for many people. Since customers may enter into a large number of transactions with different retailers, customers may find it difficult to track and organize the many records of their purchases. Because of the myriad retail transactions occurring daily, retailers and non-parties to a transaction, such as advertisers, may find it difficult to track consumer behavior and capture an account of the items that retailers are actually selling at a given time. It would be desirable to resolve these and other problems.

### SUMMARY

Disclosed is a method, comprising identifying a field of a digital document as containing information related to an order. The method may include deconstructing the field into a character string and comparing the character string with a set of regularized purchase-related expressions, thereby parsing the character string. The method may also include extracting order information from the character string if the character string meets a condition of the one regularized purchase-related expression and providing the extracted order information.

The digital document may be an email and the field is a body field of the email. The method may further comprise accessing an email account containing the email and selecting the email in the email account for parsing. The method may further include determining whether the order relates to a preexisting order and updating information related to the preexisting order with the extracted order information if the order relates to the preexisting order. The digital document may comprise a shipping document associated with the order.

The method may include determining whether the extracted order information provides sufficient purchase information of the order, facilitating a search for more information if the extracted order information does not provide the sufficient purchase information of the order, and providing results of the search for the more information. The search may be for additional order-related information related to the order. In some embodiments, the sufficient purchase information comprises one or more of: a title, a subtitle, an image, a stock-keeping unit (SKU) and a uniform resource locator (URL) associated with the order.

In the method, facilitating the search for the order may include comparing the character string with one of the set of regularized purchase-related expressions configured to extract a uniform resource locator (URL) from the character string. The method may include performing a search, for the purchase, of a vendor website associated with the purchase if the comparison of the character string does not meet a condition of the one regularized expression, thereby not providing the sufficient purchase information. The method may also include performing a web-based search for the order if the search of the vendor website does not provide the sufficient purchase information.

The method may comprise verifying that contents of the field are in a standardized character format before deconstructing the field into the series of character strings. The digital document may be one or more of: an email, and a machine-readable representation of a physical purchase document. Identifying the digital document as a purchase-related document comprises identifying a vendor name in a portion of the digital document. The field may comprise a body of an email. Deconstructing the field into a character string, according to the method, may comprise stripping hypertext markup language (HTML) tags from the field and identifying unstrapped portions of the field as containing the purchase-related information. One or more of the set of regularized purchase-related expressions may be stored in an expression template. The set of regularized purchase-related expressions may comprise a set of vendor-specific purchase-related expressions configured to facilitate extracting an identity of a vendor associated with the order.

Also disclosed is a system comprising a parsing expressions datastore that stores a set of regularized purchase-related expressions. The system may comprise an account datastore storing order information. The system may include a datastore storing one or more digital documents. The system may comprise a selection engine configured to select a digital document from the datastore. The system may include a decomposition engine configured to identify a field of the digital document as containing information related to an order. The system may comprise a formatting engine configured to deconstruct the field into a character string. The system may further include a parsing engine configured to: compare the character string with each of the set of regularized purchase-related expressions; extract order information from the character string if the character string meets a condition of one of the set of regularized purchase-related expressions; and provide the extracted order information to the account datastore.

The digital document may comprise an email and the field is a body field of the email. The system may further include an email account authorization engine configured to access an email account containing the email; and an email selection engine configured to select the email in the email account for parsing. The system may also include an order update engine configured to: determine whether the order relates to a preexisting order in the order datastore; and update, in the order datastore, information related to the preexisting order with the extracted order information if the order relates to the preexisting order. The digital document may comprise a shipping document associated with the order.

The system may further include a purchase information validation engine configured to determine whether the extracted order information provides sufficient purchase information of the order; a search interface engine configured to: facilitate a search for more information if the extracted order information does not provide the sufficient purchase information of the order; and provide results of the search for the more information. The more information may comprise additional order-related information related to the order. The sufficient purchase information may comprise one or more of: a title, a subtitle, an image, a stock-keeping unit (SKU), and a uniform resource locator (URL) associated with the order.

In the system, the search interface engine may be configured to compare the character string with one of the set of regularized purchase-related expressions configured to extract a uniform resource locator (URL) from the character string; perform a search, for the purchase, of a vendor website associated with the purchase if the comparison of the character string does not meet a condition of the one regularized expression, thereby not providing the sufficient purchase information; and perform a web-based search for the order if the search of the vendor website does not provide the sufficient purchase information. The formatting engine may be configured to verify that contents of the field are in a standardized character format before deconstructing the field into the series of character strings. The digital document may comprise one or more of: an email, and a machine-readable representation of a physical purchase document. The decomposition engine may be configured to identify the digital document as a purchase-related document by identifying a vendor name in a portion of the digital document. The field may comprise a body of an email. The formatting engine may be configured to deconstruct the field into the character string by stripping hypertext markup language (HTML) tags from the field and identifying unstrapped portions of the field as containing the purchase-related information. One or more of the set of regularized purchase-related expressions may be stored in an expression template residing in the expression datastore. The set of regularized purchase-related expressions comprises a set of vendor-specific purchase-related expressions configured to facilitate extracting an identity of a vendor associated with the order.

### BRIEF DESCRIPTION OF THE DRAWINGS

FIG. 1 shows an example of an environment for intelligent purchase crawling and retail exploration, according to some embodiments.

FIG. 2 shows an example of a purchase aggregation server, including a purchase crawler, according to some embodiments.

FIG. 3 shows an example of a purchase crawler, including an email crawler engine, according to some embodiments.

FIG. 4 shows an example of a purchase crawler, including an email parsing engine, according to some embodiments.

FIG. 5 shows an example of a purchase crawler, including an order update engine, according to some embodiments.

FIG. 6 shows an example of a purchase crawler, including a document crawler engine, according to some embodiments.

FIG. 7 shows an example of a purchase aggregation server, including a purchase organizer, according to some embodiments.

FIG. 8 shows an example of a purchase aggregation server, including a purchase portal, according to some embodiments.

FIG. 9 shows a flowchart of an example of a method for intelligently crawling purchase-related digital documents, according to some embodiments.

FIG. 10 shows a flowchart of an example of a method for intelligently extracting purchase-related information from emails, according to some embodiments.

FIG. 11 shows a flowchart of an example of a method for obtaining granular purchase-data from purchase-related emails, according to some embodiments.

FIG. 12 shows a flowchart of an example of a method for updating purchase-related orders, according to some embodiments.

FIG. 13 shows a flowchart of an example of a method for intelligently extracting purchase-related information from documents, according to some embodiments.

FIG. 14 shows a flowchart of an example of a method for parsing purchase-related documents, according to some embodiments.

FIG. 15 shows a flowchart of an example of a method for organizing crawled purchase-related information, according to some embodiments.

FIG. 16 shows a flowchart of an example of a method for prioritizing crawled purchase-related information, according to some embodiments.

FIG. 17 shows a flowchart of an example of a method for facilitating sharing of crawled purchase-related information, according to some embodiments.

FIG. 18 shows a flowchart of an example of a digital device, according to some embodiments.

FIG. 19 shows an example of a sample pizza order email, according to some embodiments.

FIG. 20 shows an example of a sample pizza order email, according to some embodiments.

### DETAILED DESCRIPTION OF EMBODIMENTS

A purchase, whether at an online retailer or a physical brick-and-mortar business, may require the maintenance and transfer of a lot of information. For instance, a customer may receive numerous emails related to an online purchase, such as the purchase confirmation email, the shipping email, and other emails related to returns/refunds, exchanges, comments. Emails from multiple online retailers may further clutter a customer's email account. Moreover, a customer may have numerous digital as well as physical commercial receipts from purchases at brick-and-mortar retailers. Various embodiments provide intelligent ways to organize digital documents relating to the numerous purchases a customer may enter into. A “digital document” is a representation on a computer-readable medium of written information. A digital document may include things like emails and physical representations of purchase documents, for instance. Various embodiments also provide intelligent ways for a customer to explore retail channels and items for sale based on an intelligent assessment of the past purchases the customer has made and other factors.

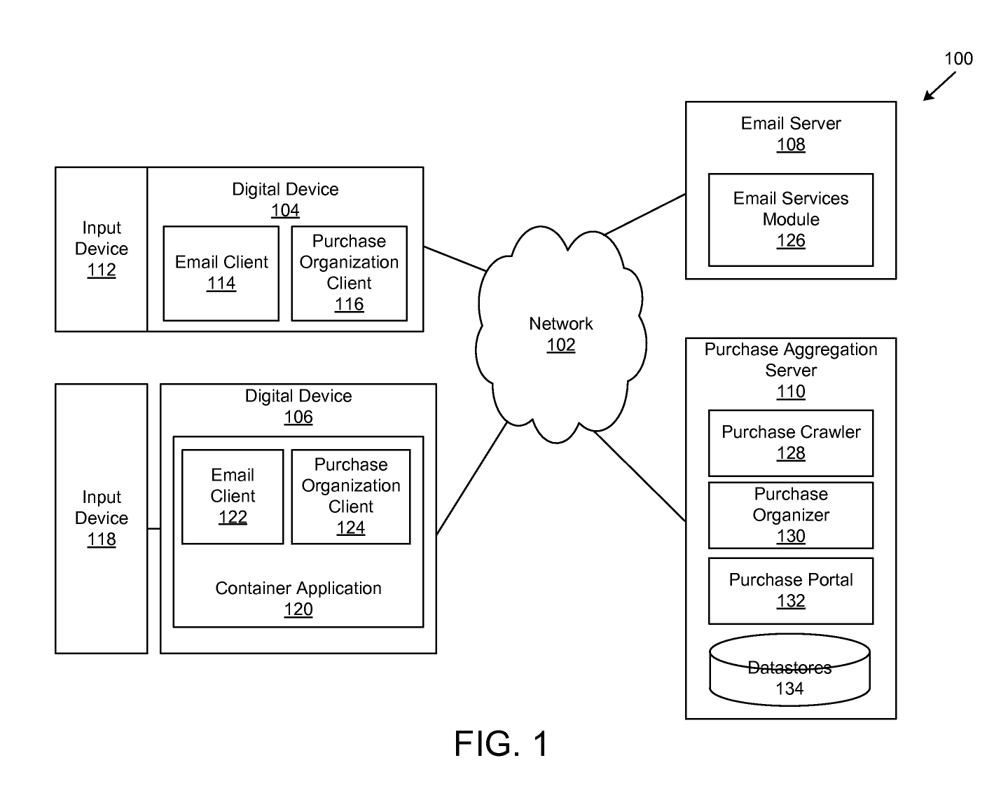

FIG. 1 shows an example of an environment 100 for intelligent purchase crawling and retail exploration, according to some embodiments. The environment 100 may include a network 102, a digital device 104, a digital device 106, an email server 108, and a purchase aggregation server 110.

The environment 100 may facilitate electronic commerce. “Electronic commerce” is the buying and selling of products or services using electronic communication systems such as the Internet, computer networks, or other forms of communication. The environment 100 may facilitate an electronic transaction. An “electronic transaction” is an agreement, communication, or movement carried out between a buyer and seller using an electronic system. The electronic transaction may be associated with online seller or retailer. An “online seller” is an entity that can sell products or services over an electronic communication system. An “online retailer” is an online seller that facilitates retail sale of products or services. An online retailer selling products or services over the environment 100 may be required to maintain and transfer a lot of information. To facilitate an electronic purchase, the online retailer may require a customer to: select an item; provide contact, payment, and identity verification information; and, if the item is a physical item (e.g., a book or a good), provide an address where a purchased item can be mailed. Once the purchaser's contact, payment, and identification information are verified, the online retailer may be required to send a confirmation of the purchase to the customer's contact information (e.g., the customer's email address) and bill the customer using the specified payment information (e.g., the customer's credit card, bank account, or PayPal account). The purchase confirmation may function as a commercial receipt that provides information such as the price, description, quantity, and other information about the item. If the purchased item is a physical item, the online retailer may also provide the purchased item to a shipper, such as Federal Express, the United Parcel Service, or the United States Postal Service. The online retailer may send shipping information such as a tracking number to a customer's contact information.

The electronic transaction in the environment 100 may be associated with a purchaser. The purchaser can be an online purchaser or a brick-and-mortar purchaser. An online purchaser is an entity that can buy products or services over an electronic communication system. An online purchaser may be required to select an item; provide contact, payment, and identity verification information; and, if the item is a physical item (e.g., a book or a good), provide an address where a purchased item can be mailed. The online purchaser may receive several emails related to an online purchase, such as the purchase confirmation email, the shipping email, and other emails related to returns/refunds, exchanges, comments. A brick-and-mortar purchaser is an entity that can buy products or services at a seller's physical store. The brick-and-mortar purchaser may have emails for purchases made at brick-and-mortar sellers. For instance, a purchaser of a product at a brick-and-mortar store, e.g., an Apple® store or a restaurant that emails receipts, may have mailed to the purchaser a receipt of the purchase. The brick-and-mortar purchaser may also have physical commercial receipts containing information of purchases at brick-and-mortar retailers. These physical receipts may include information about the price, description, quantity, and other information about items purchased. A purchaser, whether an online purchaser or a brick-and-mortar purchaser, may find it difficult to organize the numerous receipts and emails of the things the customer has bought. For example, a customer may have multiple physical purchase receipts scattered around. It would be desirable to organize these physical purchase receipts in a systematic way. Also, a purchaser may have, for each vendor, hundreds or thousands of emails in the purchaser's email inbox. Emails from a given seller may range from marketing emails to purchase confirmation emails to shipping confirmation emails. It is often difficult or impossible for the purchaser to efficiently separate emails that record a purchase from other emails. It would be desirable to provide purchaser with an efficient and intelligent system for organizing information of retail purchases.

In the example of FIG. 1, the network 102 may facilitate connection between one or more of the digital device 104, the digital device 106, the email server 108, and the purchase aggregation server 110. The network 102 may include a computer network. The network 102 may be implemented as a personal area network (PAN), a local area network (LAN), a home network, a storage area network (SAN), a metropolitan area network (MAN), an enterprise network such as an enterprise private network, a virtual network such as a Virtual Private Network (VPN), or other network. The network 102 may connect people located around a common area, such as a school, workplace, or neighborhood. The network 102 may also connect people belonging to a common organization, such as a workplace. Portions or the network 102 may include secure portions and other portions of the network 102 may include unsecured portions.

The network 102 may incorporate wireless network technologies. Wireless network technologies are computer networks that connect one or more devices to each other without the use of computer cables. Wireless networks may incorporate data packets into electromagnetic waves (e.g., radio frequency waves), and transmit the resulting packaged electromagnetic waves between devices. Compatible devices may have transmitters coupled to modulators that incorporate the information into the data packets. Compatible devices may also have receivers coupled to demodulators that extract information from the data packets.

Though FIG. 1 depicts the “network 102”, those of ordinary skill in the art will appreciate that some or even all of the network 102, in various embodiments, may simply comprise a communication medium. A communication medium is a system that transfers data between components inside a device or between devices. Examples of communication media include buses, cables, networks (as shown by the network 102 in FIG. 1), and other media. Accordingly, it will be appreciated that digital devices 104, 106, the email server 108, and the purchase aggregation server 110 may be coupled to one another using communication media such as buses, cables, networks, and other communication media.

In the example of FIG. 1, the digital device 104 may include an electronic device having a memory and a processor. The digital device 104 may allow a user access to one or more email accounts, may facilitate electronic transactions with online vendors, and may allow the user to organize information and documents relating to electronic transactions as well as brick-and-mortar transactions. The digital device 104 may also provide a user with access to a retail portal. The digital device 104 may include applications, systems management modules, one or more operating systems, device drivers, and other modules. An application is hardware and/or software configured to help a user perform specific tasks. At startup, an application may be allocated its own memory by an operating system or by systems management modules. Those of ordinary skill in the art will appreciate that an application may also share memory space with other applications or may be allocated memory by another application. Examples of applications in the digital device 104 may include productivity applications, media applications, accounting applications, network access applications (such as Internet browsers), and software development kits. A systems management module is hardware and/or software configured to manage and integrate resources and capabilities of a digital device. An operating system is hardware and/or software that manages computer hardware resources and provides common services for programs, such as applications and systems management modules. Examples of operating systems compatible with the digital device 104 may include variations of Android® operating systems, BSD®, iOS®, Mac OS®, Microsoft Windows®, Windows Phone®, as well as many variants of the UNIX® operating system. A device driver is hardware and/or software configured to provide applications and/or systems management modules the capability to interact with hardware devices. The device drivers on the digital device 104 may allow applications on the digital device 104 the capability to access hardware through driver routine calls.

The digital device 104 may include a mobile device. A mobile device is a digital device that is capable of operating without a dedicated power cable or a network cable. To this end, the digital device 104 may include an antenna, amplifiers, and filters configured to receive process wireless data signals. The digital device 104 may also include communication modules, including wireless data modules like 3G/4G communication modules, Bluetooth modules, Near Field Communication (NFC) modules, Global Positioning System (GPS) modules, and 802.11 modules such as Wi-Fi modules. The digital device 104 may also include voice capabilities to connect to wireless voice networks such as cellular phone networks. The digital device 104 may include a mobile operating system and mobile applications. A mobile operating system is an operating system that can operate on a mobile device. Mobile applications are applications that can operate on a mobile device. In some embodiments, the digital device 104 may include an iPhone®, an Android® based smartphone, a Windows® phone, a tablet using a mobile operating system, or a laptop computer.

In the example of FIG. 1, the digital device 104 may be operatively coupled to an input device 112, and may include an email client 114 and a purchase organization client 116. One or more of the input device 112, the email client 114, and the purchase organization client 116 may comprise one or more engines and datastores. An “engine” refers to computer-readable media coupled to a processor. The computer-readable media have data, including executable files, that the processor can use to transform the data and create new data. An engine can include a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. A computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. A “datastore” may be implemented, for example, as software embodied in a physical computer-readable medium on a general- or specific-purpose machine, in firmware, in hardware, in a combination thereof, or in an applicable known or convenient device or system. Datastores may include any organization of data, including tables, comma-separated values (CSV) files, traditional databases (e.g., SQL), or other known or convenient organizational formats.

The computer-readable medium may be a non-transitory computer-readable medium. FIG. 1 shows the email client 114 and the purchase organization client 116 as mobile applications inside the digital device 104. Those of ordinary skill in the art will appreciate that the email client 114 and/or the purchase organization client 116 may also execute within one or more other applications, such as web browser(s) or container application(s), as with the modules in the digital device 106.

The input device 112 may facilitate input from a user of the digital device 104. The input device 112 may comprise a scanner, a camera, a keyboard, a mouse, or a track pad. The input device 112 may comprise an optical input device that allows the capture of images such as documents or physical items. For example, the input device 112 may be a camera of a mobile phone or a scanner coupled to a tablet computing device. Though FIG. 1 shows the input device 112 directly coupled to the digital device 104 (e.g., as with a camera integrated into a housing of a mobile phone), those of ordinary skill in the art will appreciate that the input device 112 may be communicatively coupled to the digital device 104 in other ways, such as over a bus, a network cable, or a wireless network connection.

The email client 114 may facilitate reading, writing, and management of electronic mail. Electronic mail is the storage, transmission, and reception of messages between a sender and a recipient over a computer-readable medium. Content of electronic mail may include text, images, Hypertext Markup Language (HTML), media, embedded or linked objects, links, and other information. The email client 114 may interface with an email server, such as the email server 108. In various embodiments, the email server 108 may provide email services to the email client 114. The email client 114 may include a display module that facilitates the display of messages to a user of the digital device 104. The display module of the email client 114 may also be configured to receive content from the user via input devices (e.g., keyboards, mice/trackpads, and optical input devices) so that the user can compose and manage messages. The email client 114 may be configured to provide the user with management tools such as folders/organizational systems and filtering tool. In some embodiments, the email client 114 may be associated with an electronic mail service provider. An electronic mail service provider is an entity that provides an email server for a user or organization to send, receive, and store electronic mail. Examples of electronic mail service providers include Yahoo! Mail®, Microsoft Hotmail®, Google Gmail®, America Online (AOL) Mail®, Pobox, Microsoft Exchange®, mail clients related to the Mac OS and/or the iPhone, and others. The email client 114 may be a mobile email client. A mobile email client is an application (in some instances a standalone mobile application) that facilitates access to electronic mail.

In the example of FIG. 1, the purchase organization client 116 may allow a user to crawl an email inbox and document datastores for purchase-related digital documents, organize purchase-related data produced by the crawls, and access a retail exploration portal for the user. A “purchase-related email” is an electronic mail message related to a purchase a user has made. A purchase-related email may be one or more of: an order email that confirms that a purchaser has completed an electronic transaction, or a brick-and-mortar transaction to order a good or a service; a shipping email that indicates that a seller or affiliate has shipped an item; a return or refund email that indicates that documents a return or refund on behalf of the purchaser; and emails relating to other phases or portions of an order lifecycle. “Crawling” an email inbox or a datastore is the systematic evaluation of the contents of the email inbox or datastore based on search, data extraction or other algorithms. In some embodiments, the purchase organization client 116 may include a display module that facilitates the display, selection, and management of email accounts and document datastores to be parsed, a viewing of a cross-vendor catalog of items purchased by members of a retail purchase community, and a retail exploration portal of retail items suggested for a user.

In the example of FIG. 1, the digital device 106 may include an electronic device having a memory and a processor. Like the digital device 104, the digital device 106 may allow a user access to one or more email accounts, may facilitate electronic transactions with online vendors, and may allow the user to organize information and documents relating to electronic transactions as well as brick-and-mortar transactions. The digital device 106 may also provide a user with access to a retail portal. The digital device 106 may include applications, systems management modules, one or more operating systems, device drivers, and other modules. Examples of applications in the digital device 106 may include productivity applications, media applications, accounting applications, network access applications (such as Internet browsers), and software development kits. Examples of operating systems compatible with the digital device 104 may include variations of Android® operating systems, BSD®, iOS®, Mac OS®, Microsoft Windows®, Windows Phone®, as well as many variants of the UNIX® operating system.

The digital device 106 may include a desktop computer or a laptop. A desktop computer is digital device that requires a dedicated power cable for operation. A laptop is a digital device that may operate at least partially using a dedicated power cable. The laptop need not run a mobile operating system and may be configured to run a standard operating system similar to the operating system of a desktop. In various embodiments, the digital device 106 may include a network interface card to facilitate wired or wireless network access.

The digital device 106 may be operatively coupled to an input device 118, and may include a container application 120, an email client 122, and a purchase organization client 124. One or more of the input device 118, the container application 120, the email client 122, and the purchase organization client 124 may comprise engines. FIG. 1 shows the email client 122 and the purchase organization client 124 as applications residing within the container application 120. However, those of ordinary skill in the art will appreciate that the email client 122 and the purchase organization client 124 may comprise applications (e.g., standalone applications) on the digital device 106.

The input device 118 may facilitate input from a user of the digital device 106. The input device 118 may comprise a scanner, a camera, a keyboard, a mouse, or a track pad. The input device 118 may comprise an optical input device that allows the capture of images such as documents or physical items. For example, the input device 118 may be a camera or a scanner coupled to a desktop computer or laptop. The input device 118 may be coupled to the digital device 106 with a cable (e.g., a USB cable), a network connection (e.g., a wired or wireless network connection), or may be integrated into a housing of the digital device 106. Those of ordinary skill in the art will appreciate that the input device 118 may be coupled to the digital device 106 in other ways.

In the example of FIG. 1, the container application 120 may house execution of one or more component applications and processes in a memory space. A memory space of an application is an area of memory allocated during startup of the application. The container application 120 may sandbox or otherwise limit the components inside from accessing processes external to the container application 120. The container application 120 may comprise an Internet browser or a standalone application. The container application may house execution of the email client 122 and the purchase organization client 124.

The email client 122 may facilitate reading, writing, and management of electronic mail. The email client 122 may interface with an email server, such as the email server 108. In some embodiments, the email server 108 may provide email services to the email client 122. The email client 122 may include a display module that facilitates the display of messages to a user of the digital device 106. The display module of the email client 122 may also be configured to receive content from the user via input devices (e.g., keyboards, mice/trackpads, optical input devices) so that the user can compose and manage messages. The email client 122 may be configured to provide the user with management tools such as folders/organizational systems and filtering tool. In various embodiments, the email client 122 may be associated with an electronic mail service provider. For instance, the email client 122 may be associated with one or more of Yahoo! Mail®, Microsoft Hotmail®, Google Gmail®, America Online (AOL) Mail®, Pobox, Microsoft Exchange®, mail clients related to the Mac OS and/or the iPhone, or others. The email client 122 may be a web-based email client, that is accessed through the container application 120.

In the example of FIG. 1, the purchase organization client 124 may allow a user to crawl an email inbox and document datastores for purchase-related digital documents, organize purchase-related data produced by the crawls, and access a retail exploration portal for the user. In some embodiments, the purchase organization client 124 may include a display module that facilitates the display, selection, and management of email accounts and document datastores to be parsed, a viewing of a cross-vendor catalog of items purchased by members of a retail purchase community, and a retail exploration portal of retail items suggested for a user.

In the example of FIG. 1, the email server 108 may include an electronic device having a memory and a processor. The email server 108 may provide email services to one or more of the email clients 114 and 122. The email server 108 may include applications, systems management modules, one or more operating systems, device drivers, and other modules. The email server 108 may include account management services to manage the creation of email accounts, login protocols, and interface protocols. The email server 108 may support protocols that allow third-party applications (i.e., applications other than the applications that the email server 108 uses to provide email services) to gain authorization to private resources of a user's email account. The email server 108 may support token-based authorization of account resources. An example of token-based authorization is an open authorization standard such as OAuth. In various embodiments, the email server 108 may also support licensed-server protocol based authorization. With licensed-server protocol based authorization, the email server 108 may provide a third-party application with a specific license to access private resources. In the example of FIG. 1, the email server 108 may use the email services module 126 to provide one or more of the functionalities described herein.

The purchase aggregation server 110 may include an electronic device having a memory and a processor. The purchase aggregation server 110 may implement modules to crawl a user's email inboxes and document datastores for purchase-related information, organize purchase-related data resulting from the crawls, and may create a customized retail portal to help a user discover products and services the user may or may not have known about. The purchase aggregation server 110 may also provide an interactive community built around the common ecosystem of retail shopping and discovery. The purchase aggregation server 110 may include applications, systems management modules, one or more operating systems, device drivers, and other modules. Examples of applications in the purchase aggregation server 110 may include productivity applications, server applications, media server applications, and network service applications. Examples of operating systems compatible with the purchase aggregation server 110 may include variations of UNIX® server operating systems, Mac OS® server operating systems, and Microsoft Windows® server operating systems. Those of ordinary skill the in the art will appreciate that the purchase aggregation server 110 may also be implemented on a device such as a mobile device or a desktop computer.

The purchase aggregation server 110 may include a purchase crawler 128, a purchase organizer 130, a purchase portal 132, and datastores 134. One or more of the purchase crawler 128, the purchase organizer 130, the purchase portal 132, and the datastores 134 may comprise engines. One or more of the purchase crawler 128, the purchase organizer 130, the purchase portal 132, and the datastores 134 may be coupled to each other.

In the example of FIG. 1, the purchase crawler 128 may be operative to search for purchase-related documents. The purchase crawler 128 may look to data of retail purchases that purchasers are willing to provide in order to organize their retail purchases. The data may be based on simple indications of retail purchases, such as emails in the purchasers' accounts, and physical purchase receipts or pictures of purchased items that the purchasers store in datastores. To wade through the volumes of purchase-related information for a given person, the purchase crawler 128 may implement an efficient and intelligent parser to match data from emails and stored documents to a set of regularized purchase-related expressions. The purchase crawler 128 may also capture the data.

A set of “regularized purchase-related expressions” is a set of expressions used to isolate specific types of character strings from a block of text. The set of regularized purchase-related expressions employed by the purchase crawler 128 may have been implemented using a variety of programming languages, such as object oriented languages as well as scripting languages such as Perl Compatible Regular Expressions (PCRE). The implementation may use PHP, which is a general-purpose server-side scripting language originally designed for Web development to produce dynamic Web pages using packages such as Joomla, Wordpress, Concrete5, MyBB, and Drupal. The regularized purchase-related expressions may be adapted to match text to specific character strings that are likely to contain information related to a purchase. Some or all of the expressions may be implemented using a set of templates associated with a given online seller or set of online sellers. In some embodiments, some or all of the expressions may be implemented using a set of templates associated with a given brick-and-mortar seller or a set of brick-and-mortar sellers. The expressions may also relate to a combination of online and brick-and-mortar sellers. In some embodiments, even a small set (e.g., dozens) of regularized purchase-related expressions for a given online seller and/or brick-and-mortar seller may capture nearly all permutations of purchase-related emails from that online seller and/or brick-and-mortar sellers.

The set of regularized purchase-related expressions implemented by the purchase crawler 128 may include a set of syntactical rules. The following discussion provides an overview of several syntactical rules useful for an implementation in a scripting language such as Perl. The set of regularized purchase-related expressions implemented by the purchase crawler 128 may contain symbols to indicate a beginning and end of an expression. For instance, the slash character (“/”) may be used to indicate the beginning and end of a match. More specifically, if the expression “/brown!” were used against the text “the quick brown fox jumped over the fence”, the match would be the word “brown”. The match would begin at the tenth character of the text and would end at the fourteenth character of the text.

The set of regularized purchase-related expressions implemented by the purchase crawler 128 may also include qualifiers or modifiers. The set of regularized purchase-related expressions may also include escape character sequences that would be used to literally match the character corresponding to a qualifier/modifier. For instance, assuming the question mark character “?” were a qualifier/modifier, the backslash character “\” may be used to match the question mark character. An example of syntax would be the expression “\?”. The set of regularized purchase-related expressions may include symbols that direct a match to any character in a sequence of characters. For example, the period (dot) character “ ”. may be used to signify matching any character in a set of sequences. More specifically, the expression “/a./” would match the following character strings: “ab”, “ac”, and “az”, among other strings. The set of regularized purchase-related expressions may include symbols that direct a match to the start or end of a line. For instance, the caret character, “̂” may direct matching to a start of a line while the dollar sign “$” may direct matching to the end of a line. The expression “/̂red/” would match text only if the text contained the word “red” on the first line of the text. The expression “/fox$/” would match text only if the text contained the word “fox” on the last line.

The set of regularized purchase-related expressions implemented by the purchase crawler 128 may include qualifier symbols that direct a match to how many times a character would match. For instance, the question mark symbol “?” may direct a match if a character sequence occurs zero or one times in a block of text. That is, the expression, “/a?/” may match the first occurrence first occurrence of the character ‘a’. But since the character “a” is optional (based on the use of the question mark character, “?”), the expression would also match if the character “a” were absent. The expression “/a?/” may match the character “a” from the text “bb a”. The expression “/a?/” may further match the null character “ ” from the text “bb”.

As another example regarding the purchase crawler 128, the asterisk symbol “*” may direct a match if a character sequence occurs zero or more times in a block of text. That is, the expression, “/a*/” would start matching the first occurrence of the character “a” and continue until the expression keeps on encountering the character “a”. The expression “/a*/” would match the character string “a” from the text “bb a”, would match the character string “aaa” from the text “bb aaa”, the character string “aa” from the text “bb aab”, and the null character string “ ” from the text “bb”.

As yet another example regarding the purchase crawler 128, the plus symbol “+” may direct a match if a character string occurs one or more times in a block of text. That is, the expression “/a+/” would start matching the first occurrence of the character “a” and continue till the expression keeps on encountering the character “a”. The expression “/a+/” would match the character string “a” from the text “bb”, the character string “aaa” from the text “bb aaa”, but would NOT match any character string from the text “bb” as in the last case, the expression would not find the character “a” in the text.

As still another example, the bracket symbols “{” and “}” may be used to direct a match to the minimum or maximum number of times, or the exact number of times a character string appears in a block of text. For instance, the expression “/a{2, 5}/” would match at least “aa” and at most “aaaaa”. The expression “/a{3}/” would match “aaa” but not match “aa”.

The set of regularized purchase-related expressions may produce “greedy” match results, meaning that the expression will return the longest matching string if multiple strings may be returned by a match. For instance, the expression “/a+” will start matching when the expression sees the first instance of the character “a” and will stop only when the expression sees the last contiguous “a”. The expression need not stop anywhere in between. As another example, the expression “/a{2, 5}/” would choose to match the character string “aaaaa” over the character string “aa”, even though both may potentially match the expression, because the “greediness” property.

The set of regularized purchase-related expressions implemented by the purchase crawler 128 may include a scope qualifier that adds cardinality to the expressions. For instance, the parentheses symbols “(” and “)” may be used as scope qualifiers. More specifically, the expression “/(red)/” may match the character strings “red” or “redred” or “redredred” and so on. It may be possible to nest scopes. For example, the expression “/(red)+(fox)*)+/ would match “red fox” or “redred fox” or “red” or “red foxred fox”.

In some embodiments, the set of regularized purchase-related expressions implemented by the purchase crawler 128 may include characters that direct a match to a character class. In some embodiments the square bracket characters “[” and “]” may be used to specify character classes. For example, the expression “/[abc]/” could match “a”, “b”, or “c”. The expression “/[abz]/” would match the characters “a”, “b”, or “z”; the expression “/[a-e]/” would match the range of characters between “a” and “e”. The set of regularized purchase-related expressions may specify a range inclusive of a specified range. For instance, the expression “/[̂abc]/” may match if the character is not “a” and not “b” and not “c”. The set of regularized purchase-related expressions may use mixed directives. For instance, the expression “/[apz0-9]/” would match “a” or “p” or “z” or any digit. The expression “/[̂0-9]/” would match anything but a digit. The set of regularized purchase-related expressions can include a cardinality added to a character class. For instance, the expression, “/[abc]+/” would match “a” or “b” or “c” or “ab” or “ac” or “abc” or “aabbcc” and so on.

The set of regularized purchase-related expressions implemented by the purchase crawler 128 may make use of predefined character classes. For instance, the expression, “\s” may be used for any space character; the expression, “\d” may be used for any digit, equivalent of [0-9]; the expression “\w” may be used for any alphanumeric character and a few other common characters, roughly equivalent of [0-9a-z_-]; the expression “\D” may be the inverse of \d, matching anything but a digit; and the expression “\W” may be the inverse of \w, matching anything but an alphanumeric. The listed predefined character classes are by way of example only and other the regularized purchase-related expressions may make use of other predefined sets of character classes.

The set of regularized purchase-related expressions implemented by the purchase crawler 128 may include characters that direct a match using qualifiers, such as a logical OR qualifier using the pipe symbol “|”. For instance, the expression “/red|brown!” could match the character strings “red” or “brown”. Scope qualifiers may delimit the left or right hand side of an OR clause and the overall scope of the OR clause itself. For example, the expression “/(red|brown) fox!” could match the character string “red fox” or the character string “brown fox”. The set of regularized purchase-related expressions may include characters that direct a match using line parameters or case parameters. Therefore, the set of regularized purchase-related expressions may direct a match across multiple lines, may direct a case insensitive match, or may direct matching new line characters. The entire set of syntactical rules described herein is to illustrate examples of methods of constructing regularized purchase-related expressions with a scripting language. It is noted that other syntactical rules may apply to scripts, and that other languages (e.g., object oriented languages) may implement these and other similar sets of regularized purchase-related expressions.

The set of regularized purchase-related expressions implemented by the purchase crawler 128 may include characters that direct a capturing matched sequences of characters. For instance the set of regularized purchase-related expressions may be configured to capture the sub-text that an expression has matched. For example, to capture a cost summary (e.g., price) information from a block of text, the purchase crawler 128 may use an expression like: “/̂Price:\s+\$[\d\,\.]+/msi”. The expression may match some text like: “Price: $10.00”. However, the purchase crawler 128 may still need to capture the actual price, i.e., the “10.00”. To do this, the purchase crawler 128 may add a pair of parenthesis around the text that it is seeking to capture. Therefore, the purchase crawler 128 may implement the following expression: “/̂Price:\s+\$([\d\,\.]+)/msi”. Now the purchase crawler 128 may be configured to capture the string “10.00”. As such, the cost summary field may be captured.

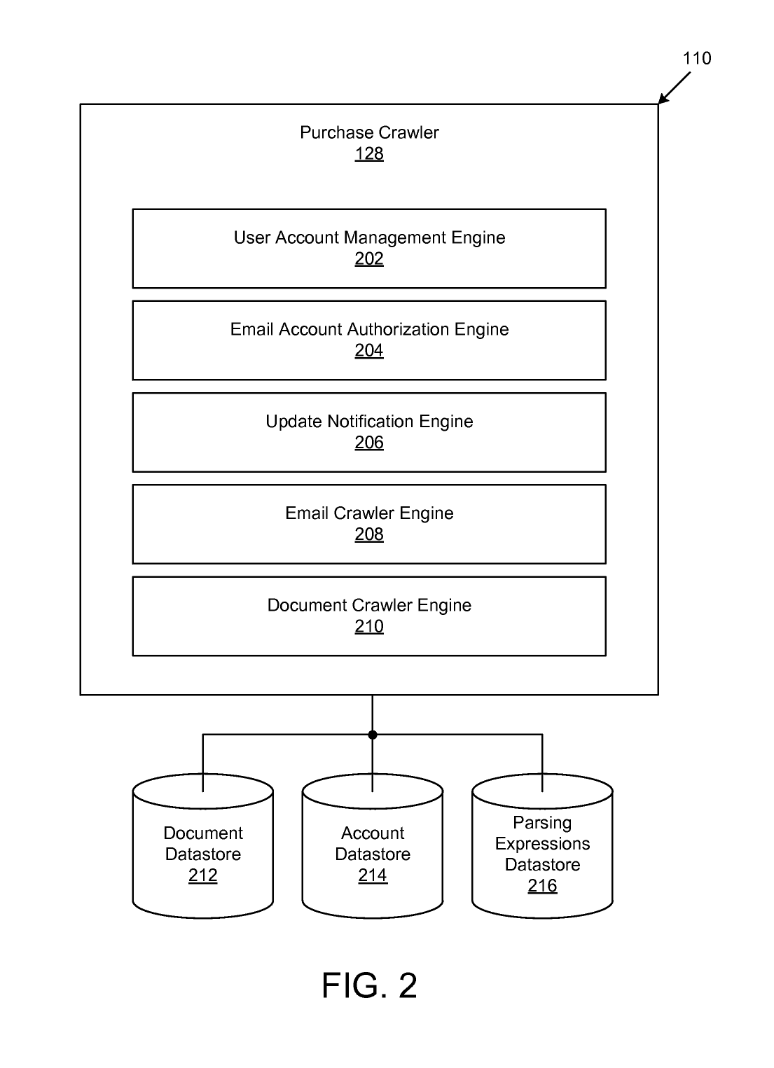

Using the set of regularized purchase-related expressions, the purchase crawler 128 may identify specific emails or documents associated with a given purchaser (e.g., online purchaser or brick-and-mortar purchaser). The purchase crawler 128 may also intelligently parse the emails or documents for purchase-related information, and may provide the purchase-related information to other modules, such as the purchase organizer 130 or the purchase portal 132. The use of the purchase crawler 128 to identify purchase-related expression is discussed in greater detail below. FIGS. 2-6 and 9-15 further discuss the purchase crawler 128.

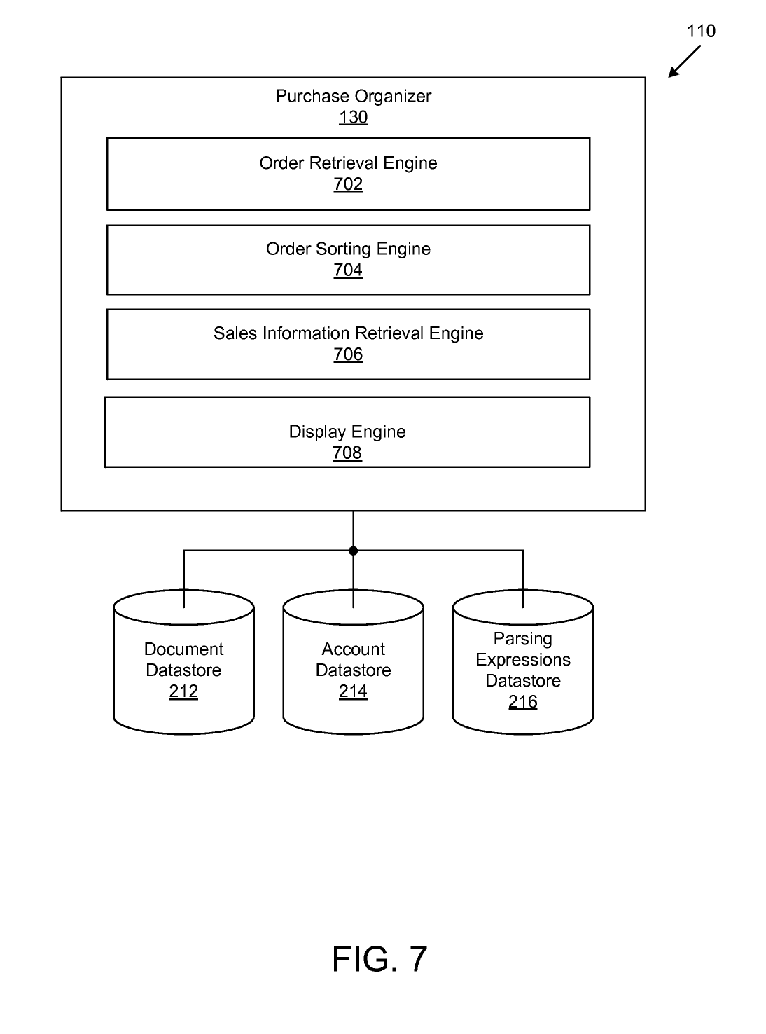

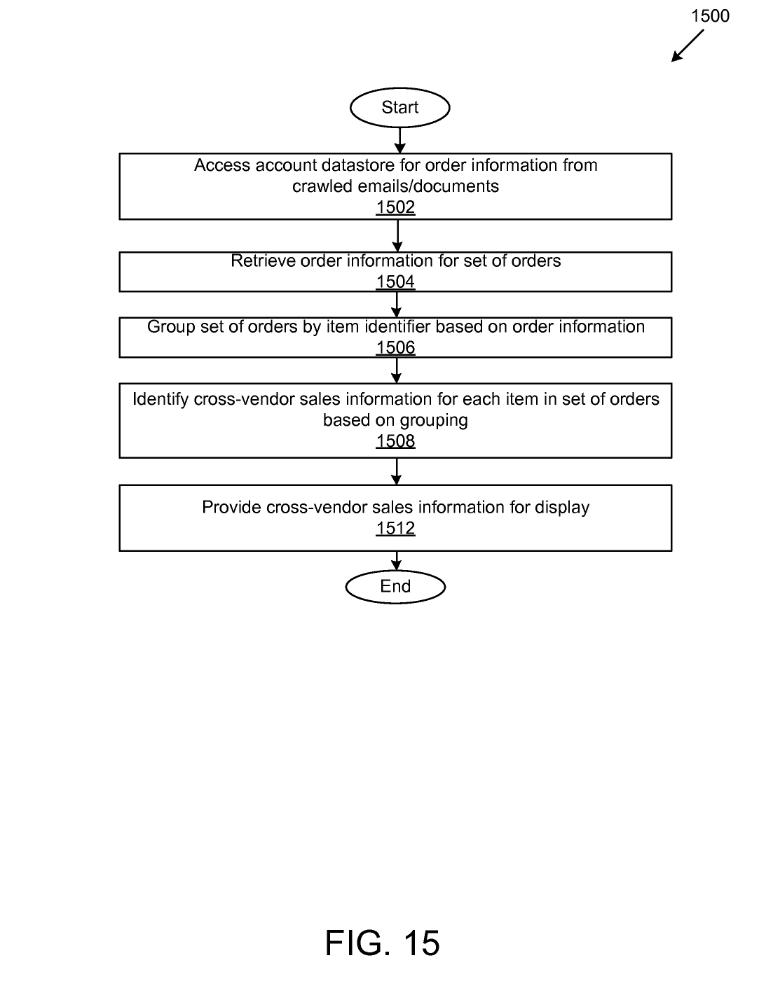

In the example of FIG. 1, the purchase organizer 130 may include hardware engines operative to organize purchase-related data, including the purchase-related data gathered as a result of email or datastore crawls by the purchase crawler 128. The purchase organizer 130 may arrange the purchaser-related data in a manner that is convenient to consumers, retailers, or third-parties such as advertisers. For example, the purchase organizer 130 may gather sales information of items sold by different vendors, may analyze the sales information using stochastic and other methods, and may provide statistics, such as the types of items being sold, the price of items being sold, the types of vendor selling specific types of items, and the types of purchasers buying specific types of items. In various embodiments, the purchase organizer 130 may provide entities such as consumers, retailers, or third-parties information about the items actually being sold rather than an estimate of what is likely to sell. As the purchase organizer 130 may rely on information provided by purchasers, statistics from the purchase organizer 130 may be more accurate than predictive advertising models. FIGS. 7 and 15 further discuss the purchase organizer 130.

In the example of FIG. 1, the purchase portal 132 may include engines operative to create a closed purchase-centric retail network system. A “closed network system” is a system limited to a specific set of users who have obtained permissions for use, have provided authentication credentials, and whose authentication credentials have been verified. The retail network system of the purchase portal 132 may be limited to people who have indicated a desire to have their email accounts and/or datastores crawled for purchase-related documents. The purchase portal 132 may allow users to browse through purchased items, search for items they have purchased, track the shipping statuses of items purchased, share their purchases, and notes/tags, and get intelligent summaries of their purchases. The purchase portal 132 may also allow users to conveniently view an online seller's contact details and other information of an item the users have purchased.

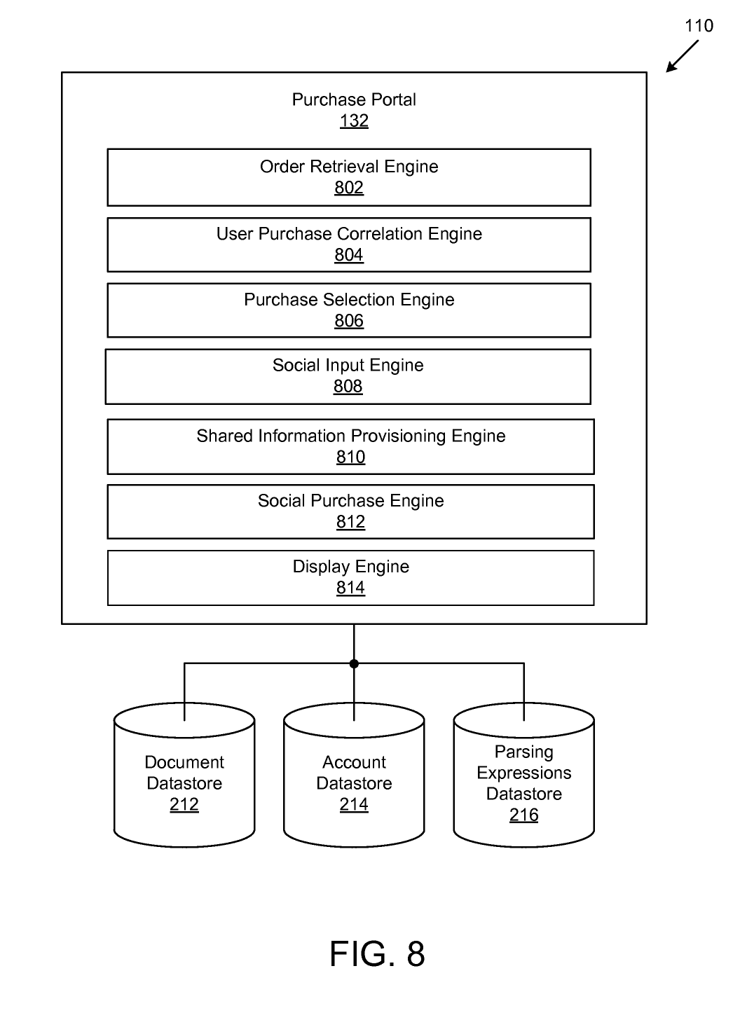

The purchase portal 132 may be limited to users who desire to explore online shopping based on intelligent analyses of their past purchases. The purchase portal 132 may facilitate creation of user accounts. The user accounts may or may not be related to the user accounts associated with the purchase crawler 128. The purchase portal 132 may also include on-site and off-site socialization tools. A “socialization tool” is a combination of hardware and/or software with which a user can have a conversation about something the user has purchased. The purchase portal 132 may suggest purchases based on past purchases by a user's or the user's friends, associates, or people in the user's demographic group. The purchase portal 132 may also facilitate the display of suggested purchases. The purchase portal 132 may interface with third parties such as advertisers and/or online sellers to monetize the retail exploration process. FIGS. 8 and 16-18 further discuss the purchase portal 132.

In the example of FIG. 1, the datastores 134 may be implemented as software embodied in a physical computer-readable medium on a general- or specific-purpose machine, in firmware, in hardware, in a combination thereof, or in an applicable known or convenient device or system. Datastores may include any organization of data, including tables, comma-separated values (CSV) files, traditional databases (e.g., SQL), or other known or convenient organizational formats. The datastores 134 may include one or more of a document datastore, an account datastore, and a parsing expressions datastore. The document datastore may store a set of documents that a user wishes to have parsed for purchase-related information. The account datastore may store user account information and purchase-related information obtained as a result of digital document crawling. The parsing expressions datastore may include a set of parsing expressions to be used for extracting purchase-related data from digital documents.

In the example of FIG. 1, each of the purchase organization client 116, the purchase organization client 124, the purchase crawler 128, the purchaser organizer 130, and the purchase portal 132 implements significant contributions to the level of technology known in the electrical and computer arts. For instance, each of the purchase organization client 116, the purchase organization client 124, the purchase crawler 128, the purchaser organizer 130, and the purchase portal 132 isolate purchase-related information from a large volume of digital documents using highly efficient parsing systems and methods that focus on the types of data sellers are likely to provide to purchasers for documenting purchases. Each of the purchase organization client 116, the purchase organization client 124, the purchase crawler 128, the purchaser organizer 130, and the purchase portal 132 allows the extraction and organization of purchase-related information without the increased memory consumption and processing power required by existing systems and/or methods. Each of the purchase organization client 116, the purchase organization client 124, the purchase crawler 128, the purchaser organizer 130, and the purchase portal 132 therefore provides one or more technical solutions to one or more technical problems, particularly in the electrical and computer arts.

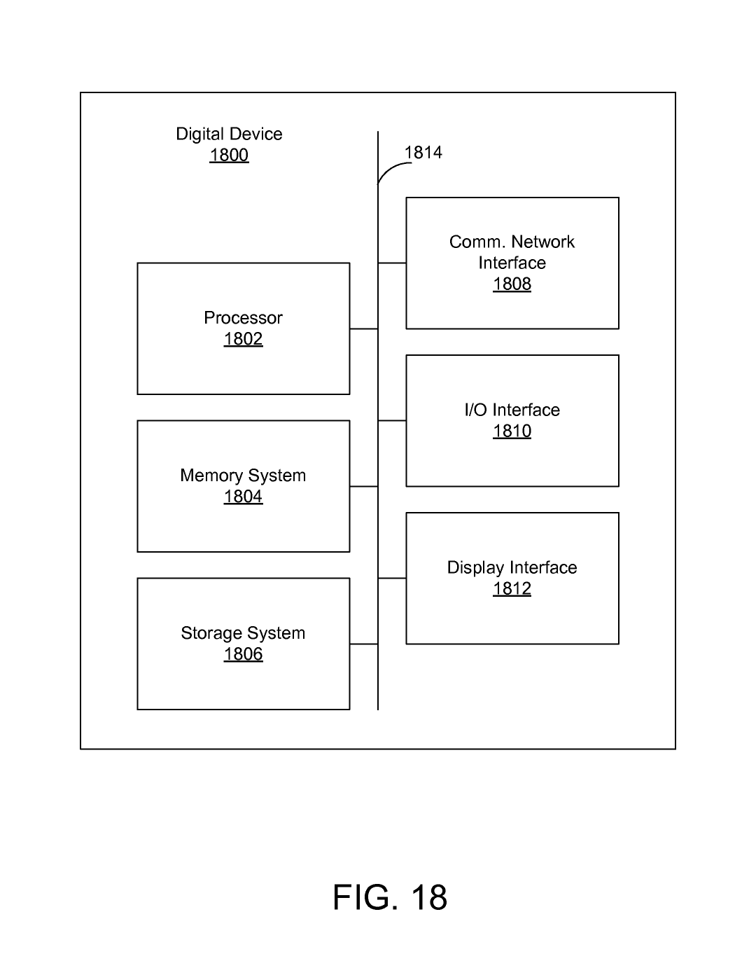

FIG. 2 shows an example of a purchase aggregation server 110, including a purchase crawler 128, according to some embodiments. In the example of FIG. 2, the purchase crawler 128 may include a user account management engine 202, an email account authorization engine 204, an update notification engine 206, an email crawler engine 208, and a document crawler engine 210. Any or all of the engines 202-210 may include a processor and memory. In some embodiments one or more of the engines 202-210 share a processor and/or memory. The purchase crawler 128 may be implemented on a digital device, such as the digital device 1800 in FIG. 18. The purchase crawler 128 may be coupled to a document datastore 212, an account datastore, and a parsing expressions datastore 216.

In the example of FIG. 2, the user account management engine 202 may interface with a client (e.g., one of the purchase organization clients 116 and 124 in FIG. 1) to receive login information. Login information is a set of data used to authenticate the identity of a user so that the user may enter into a closed retail network. Login information may take the form of a set of character strings sent to the user account management engine 202 over a network (e.g., the network 102 in FIG. 1). The user account management engine 202 may be operative to create or manage accounts associated with users. The accounts may be stored in the account datastore 214. The user account management engine 202 may be operative to read and write account data into the account datastore 214. The user account management engine 202 may interface with email servers (e.g., the email server 108 in FIG. 1) over a network to facilitate selection of email accounts for purchase-related crawling. The user account management engine 202 may also interface with email clients (e.g., one or more of the email clients 114 and 122 in FIG. 1) over a network. The user account management engine 202 may maintain a list of email accounts that have been crawled in the account datastore 214. The user account management engine 202 may also maintain a set of electronic representations of purchase documents and photographical representations of purchased products stored in the document datastore 212.

The email account authorization engine 204 may be operative to manage authorizations to access private resources of emails. The email account authorization engine 204 may receive email authorization indicators from email service providers to facilitate access to email resources. The email account authorization engine 204 may manage token based access. “Token based” authorization is authorization that uses a unique identifier such as a token from an email service provider to indicate that an email account holder has permitted access to specific private resources associated with an email address. The unique identifier may allow the private resources to be shared without requiring the account holder to provide the email account authorization engine 204 email access credentials. The email account authorization engine 204 may also manage open authorization token-based protocols, such as OAuth protocols. The email account authorization engine 204 may manage licensed-server protocol based authorization, over which the email account authorization engine 204 receives a license from an email service provider to access specific resources. Advantageously, the email account authorization engine 204 may access private resources associated with email accounts without storing email account passwords in the datastores 134. The email account authorization engine 204 may also manage private resources using authorization indicators like an email account identifier and password. The email account authorization engine 204 may interface with email servers (e.g., the email server 108 in FIG. 1) and email clients (e.g., one or more of the email clients 114 and 122 in FIG. 1) over a network.

The update notification engine 206 may manage recrawling notifications. A “recrawling notification” is an indication that an email account that has previously been crawled needs to be crawled again. The update notification engine 206 may interface with purchase organization clients (e.g., the purchase organization clients 116 and/or 124) over a network.

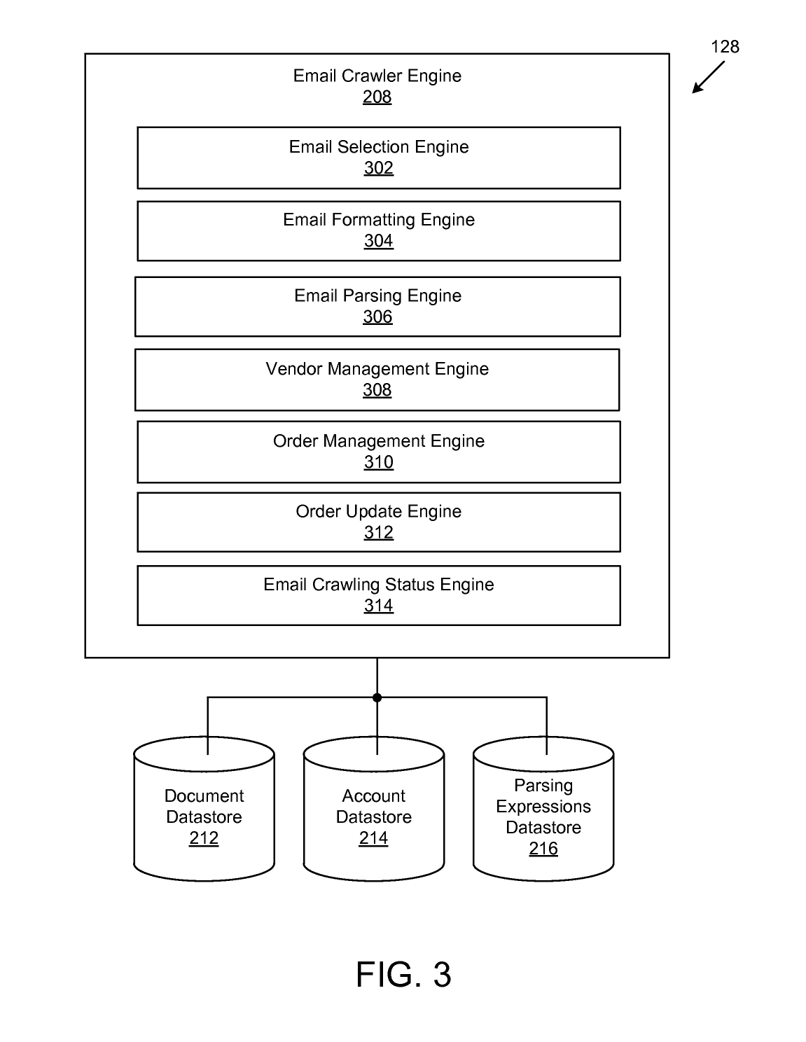

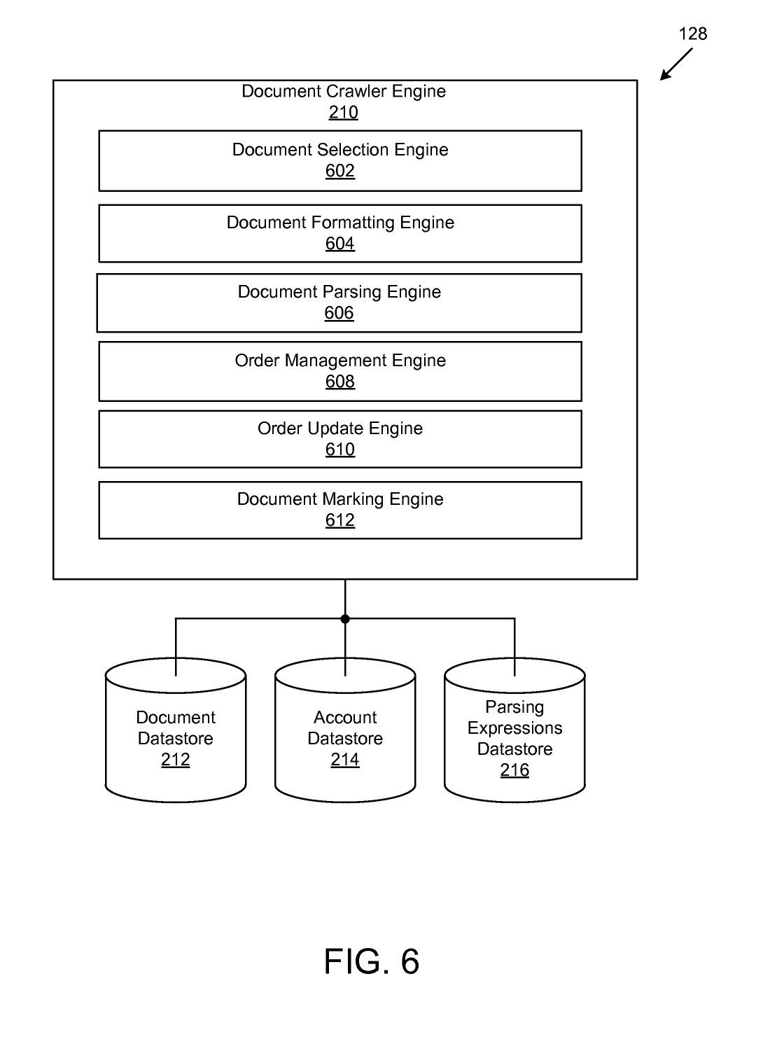

The email crawler engine 208 may be operative to systematically evaluate the contents of an email inbox based on search, data extraction or other algorithms. FIGS. 3, 4, and 5 show portions of the email crawler engine 208 in greater detail. The document crawler engine 210 may be operative to systematically evaluate the contents of documents in the document datastore 212 based on search, data extraction or other algorithms. FIG. 6 shows portions of the document crawler engine 210 in greater detail.

In the example of FIG. 2, the document datastore 212 may store documents and emails that are to be parsed or have been parsed, saved parts of emails, and other documents relevant to the operation of the purchase crawler 128. The account datastore 214 may store user account information, email authorization and account information, order information, and other data for the purchase crawler 128. The parsing expressions datastore 216 may store parsing expressions for the email crawler engine 208.

FIG. 3 shows an example of a purchase crawler 128, including an email crawler engine 208, according to some embodiments. In the example of FIG. 3, the email crawler engine 208 may include an email selection engine 302, an email formatting engine 304, an email parsing engine 306, a vendor management engine 308, an order management engine 310, an order update engine 312, and an email crawling status engine 314. The email crawler engine 208 may be coupled to a document datastore 212, an account datastore, and a parsing expressions datastore 216.

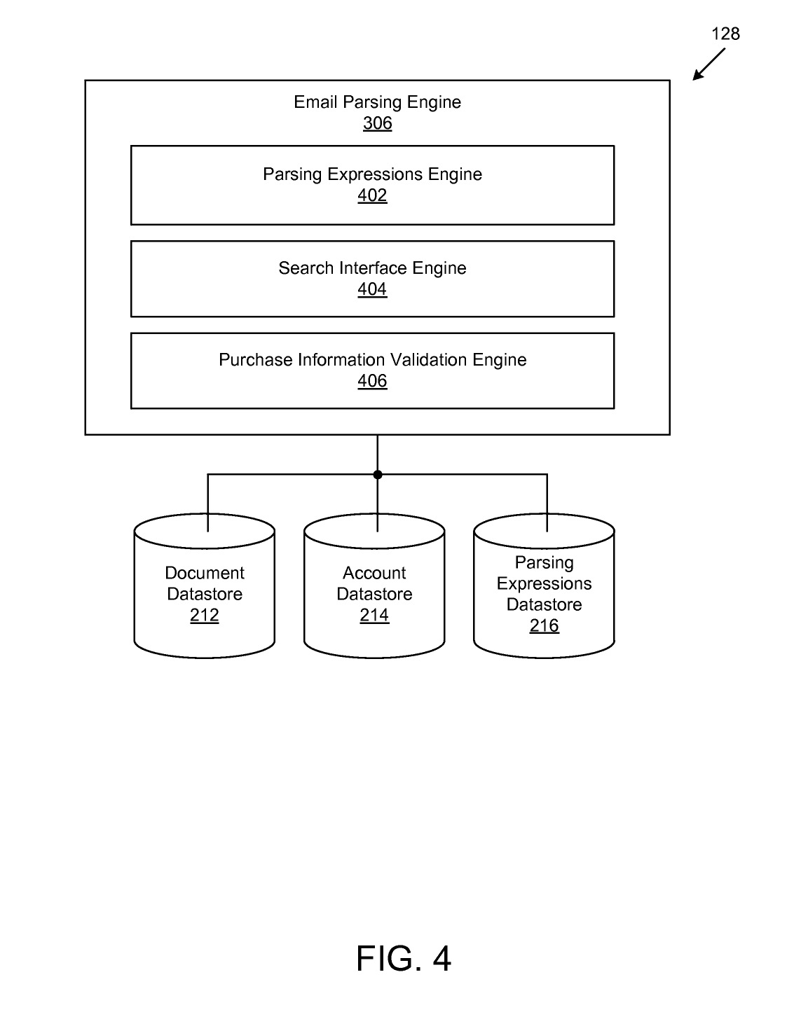

The email selection engine 302 may be operative to select specific emails in an authorized email account. The email selection engine 302 may also be configured to put emails in a sort order. A “sort order” is an arrangement of emails and/or documents in a manner that facilitates processing or data extraction from the emails/documents. The email selection engine 302 may also be configured to select emails in the sort order for further processing. The email selection engine 302 may include simple word parsers to parse portions of emails (e.g., the subject field of emails). The email formatting engine 304 may be operative to decompose emails into constituent parts or fields such as a subject, indicators of attachments, the email body, and other parts. The email formatting engine 304 may also be operative to organize the constituent parts and preformat emails for parsing. The email parsing engine 306 may be operative to parse character strings, determine whether characters match expressions obtained from the parsing expressions datastore 216, and capture matches. The email parsing engine 306 may be adapted to apply sets of regularized purchase-related expressions to blocks of text. FIG. 4 shows the email parsing engine 306 in greater detail.

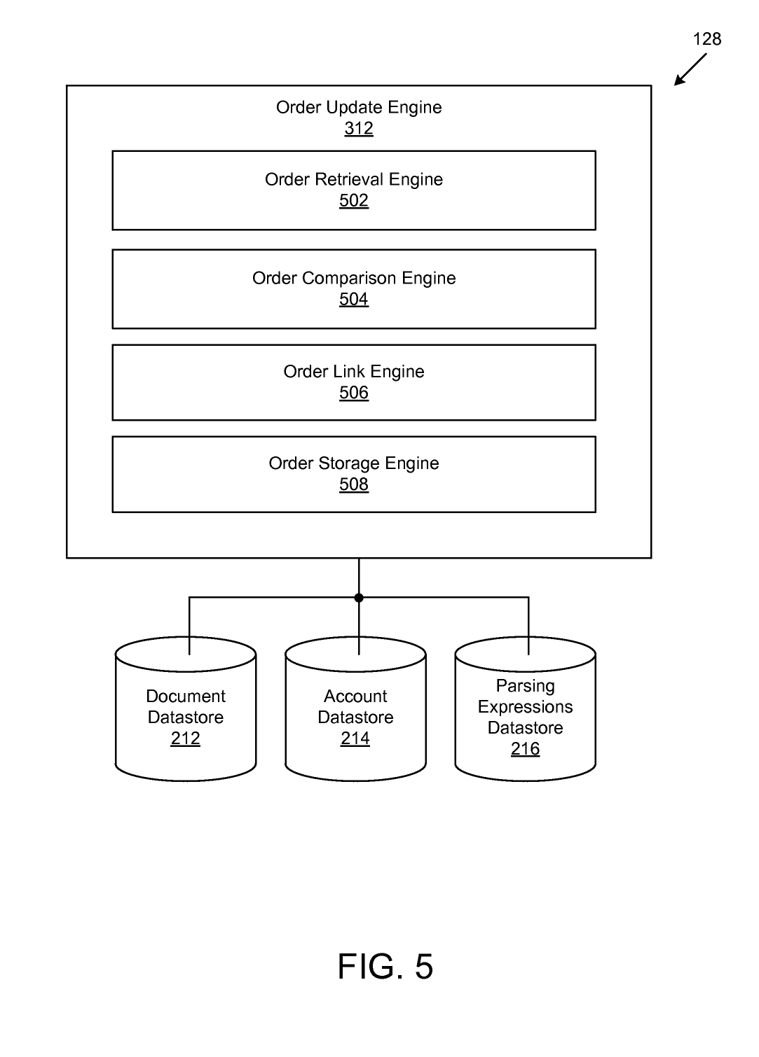

In the example of FIG. 3, the vendor management engine 308 may manage relevant vendor information using the extracted purchase-related information. The vendor management engine 308 may interface with the account datastore 214 and the parsing expressions datastore 216. The order management engine 310 may be operative to manage orders in the account datastore 214. The order update engine 312 may also manage aspects of orders in the account datastore 214. The order update engine 312 may also interface with the account datastore 214. FIG. 5 shows the order update engine 312 in greater detail.

In the example of FIG. 3, the document datastore 212 may store documents and emails that are to be parsed or have been parsed, saved parts of emails, and other documents relevant to the operation of the purchase crawler 128. The account datastore 214 may store user account information, email authorization and account information, order information, and other data for the purchase crawler 128. The parsing expressions datastore 216 may store parsing expressions for the email parsing engine 306 as well as other modules in the email crawler engine 208.

FIG. 4 shows an example of a purchase crawler 128, including an email parsing engine 306, according to some embodiments. In the example of FIG. 4, the email parsing engine 306 may include a parsing expressions engine 402, a search interface engine 404, and a purchase information validation engine 406. The email parsing engine 306 may be coupled to a document datastore 212, an account datastore, and a parsing expressions datastore 216.

The parsing expressions engine 402 may be operative to apply specific sets of regularized purchase-related expressions to portions of emails. The parsing expressions engine 402 may interface with the parsing expressions datastore 216, the account datastore 214, and the document datastore 212. The search interface engine 404 may be operative to perform network (e.g., Internet) searches based on information obtained by other modules in the email parsing engine 306. The search interface engine 404 may implement web search application programming interfaces (APIs) like Yahoo! Search Boss® web search APIs. The purchase information validation engine 406 may be operative to determine whether information from the other modules in the email parsing engine 306 have produced sufficient purchase information. “Sufficient” purchase information is an amount of information required to uniquely identify an order. Sufficient purchase information may include a combination of: a vendor name, an order identifier, and item information.

In the example of FIG. 4, the document datastore 212 may store documents and emails that are to be parsed or have been parsed, saved parts of emails, and other documents relevant to the operation of the purchase crawler 128. The account datastore 214 may store user account information, email authorization and account information, order information, and other data for the purchase crawler 128. The parsing expressions datastore 216 may store parsing expressions for the email parsing engine 306 as well as other modules in the email crawler engine 208.

FIG. 5 shows an example of a purchase crawler 128, including an order update engine 312, according to some embodiments. In the example of FIG. 5, the order update engine 312 may include an order retrieval engine 502, an order comparison engine 504, an order link engine 506, and an order storage engine 508. The order update engine 312 may be coupled to a document datastore 212, an account datastore, and a parsing expressions datastore 216.

In the example of FIG. 5, the order retrieval engine 502 is operative to retrieve orders from the account datastore 214. The order comparison engine 504 is operative to compare order information obtained as a result of purchase-related crawling and parsing with orders in the account datastore 214. The order link engine 506 and the order storage engine 508 are operative, respectively, to link and store orders in the account datastore 214.

In the example of FIG. 5, the document datastore 212 may store documents and emails that are to be parsed or have been parsed, saved parts of emails, and other documents relevant to the operation of the purchase crawler 128. The account datastore 214 may store user account information, email authorization and account information, order information, and other data for the purchase crawler 128. The parsing expressions datastore 216 may store parsing expressions.

FIG. 6 shows an example of a purchase crawler 128, including a document crawler engine 210, according to some embodiments. In the example of FIG. 6, the document crawler engine 210 may include a document selection engine 602, a document formatting engine 604, a document parsing engine 606, an order management engine 608, an order update engine 610, and a document marking engine 612. The document crawler engine 210 may be coupled to a document datastore 212, an account datastore 214, and a parsing expressions datastore 216.

The document selection engine 602 may be operative to select specific documents in the document datastore 212 for parsing. The document selection engine 602 may also be configured to put the documents in a sort order. The document selection engine 602 may also be configured to select documents in the sort order for further processing. The document selection engine 602 may include simple word parsers to parse portions of documents. The document formatting engine 604 may be operative to decompose documents into constituent parts or fields. The document formatting engine 604 may also be operative to organize the constituent parts and preformat documents for parsing. The document parsing engine 606 may be operative to parse character strings, determine whether characters match expressions obtained from the parsing expressions datastore 216, and capture matches. The document parsing engine 606 may be adapted to apply sets of regularized purchase-related expressions to blocks of text.

The order management engine 310 may be operative to manage orders in the account datastore 214. The order update engine 312 may also manage aspects of orders in the account datastore 214. The order update engine 312 may also interface with the account datastore 214. FIG. 5 shows the order update engine 312 in greater detail.

In the example of FIG. 6, the document datastore 212 may store documents and emails that are to be parsed or have been parsed, saved parts of emails, and other documents relevant to the operation of the purchase crawler 128. In this example, the document datastore 212 may store electronic representations of purchase documents. An electronic representation of a purchase document is a representation of a purchase document (e.g., a receipt) in a non-transitory computer-readable medium. An example of an electronic representation of a purchase document is a scan or a photograph of a receipt. In this example, the document datastore 212 may also store photographical representations of purchased products. A photographical representation of a purchased product is a photograph of the product or the packaging of the product. An example of a photographical representation of a purchased product is a photograph of a product box taken by a user. The account datastore 214 may store user account information, email authorization and account information, order information, and other data for the purchase crawler 128. The parsing expressions datastore 216 may store parsing expressions for the document parsing engine 606 as well as other modules in the document crawler engine 210.

FIG. 7 shows an example of a purchase aggregation server 110, including a purchase organizer 130, according to some embodiments. In the example of FIG. 7, the purchase organizer may include an order retrieval engine 702, an order sorting engine 704, a sales information retrieval engine 706, and a display engine 708. The purchase organizer 130 may be coupled to a document datastore 212, an account datastore 214, and a parsing expressions datastore 216.

In the example of FIG. 7, the order retrieval engine 702 may be operative to obtain order information from crawled emails or documents. The crawled emails or documents may be representations of emails or documents in the document datastore 212 or in the email inbox of an account holder. “Crawled” emails or documents indicates that the emails or documents were analyzed for purchase-related information with a purchase crawler (e.g., the purchase crawler 128 in FIGS. 1-6). “Crawled” emails or documents may also signify emails or documents having purchase-related information extracted from them by a purchase crawler. The order retrieval engine 702 may also be operative to retrieve order information, e.g., a title, a subtitle, a stock-keeping unit (SKU), a URL, a price, a quantity, and other information, for a set of orders in the account datastore 214. The order sorting engine 704 may be operative to group sets of orders.

The sales information retrieval engine 706 may be operative to identify cross-vendor information for sets of orders. The sales information retrieval engine 706 may take, as an input parameter, a group of orders. The sales information retrieval engine 706 may also run structured queries on information in the account datastore 214 and/or web API calls to facilitate web searching. The sales information retrieval engine 706 may use Yahoo! Boss® web API calls. The display engine 708 may be operative to facilitate the display of items and sales information.

In the example of FIG. 7, the document datastore 212 may store documents and emails that are to be parsed or have been parsed, saved parts of emails, and other documents relevant to the operation of the purchase organizer 130. The account datastore 214 may store user account information, email authorization and account information, order information, and other data for the purchase organizer 130. The parsing expressions datastore 216 may store parsing expressions.

FIG. 8 shows an example of a purchase aggregation server 110, including a purchase portal 132, according to some embodiments. In the example of FIG. 8, the purchase portal 132 may include an order retrieval engine 802, a user purchase correlation engine 804, a purchase selection engine 806, a social input engine 808, a shared information provisioning engine 810, a social purchase engine 812, and a display engine 814. The purchase portal 132 may be coupled to a document datastore 212, an account datastore 214, and a parsing expressions datastore 216.

The order retrieval engine 802 may be operative to manage user information by receiving and transmitting user identifiers associated with users in the account datastore 214. The order retrieval engine 802 may also be operative to query the account datastore 214 for information related to a user, such as the purchases in the account datastore 214 associated with the user.

The user purchase correlation engine 804 may be operative to associate targeting keywords with a user's past purchases. “Targeting keywords” are keywords that can be used to search for products and provide product purchase recommendations based on the search results. The user purchase correlation engine 804 may employ a table that associates words in the user's past purchases with targeting keywords.

The social input engine 808 may facilitate social input regarding items purchased and items to be purchased. “Social input” is an input reflecting the communication of a purchase or purchase-related information from one member of a community to another. The social input may comprise one or more proprietary social inputs such as invitation inputs, polling inputs, and recommendation inputs. An invitation input is an invitation from one member of a community to another member of the community to attend or participate in a purchased item. For instance, a user who purchased a concert ticket may invite another user to attend the concert. A polling input is a request from one member of a community to another member of the community for an opinion on an item that the one member wishes to purchase or has purchased. For example, a user may poll the user's friends whether they think it would be better to purchase a baseball bat or new basketball shoes in the near future. A recommendation input is a suggestion from member of a community to another member of the community about the quality or rating of a purchased item or an item to be purchased. For instance, one user may supply a recommendation of books based on the user's personal experiences. In various embodiments, the social input may comprise one or more third-party social inputs. A third-party social input is a social input using a third-party service provider such as Facebook® or PInterest®. The social input engine 808 may use authorization methods such as token-based authorization and license-based authorization to connect to the third-party service provider. In some embodiments, the social input engine 808 may interface with a purchase organization client (e.g., one of the purchase organization clients 116 or 124 in FIG. 1).

The shared information provisioning engine 810 may create prediction categories for users. A “prediction category” is a set of items that a user is likely to purchase based on the user's interests. The shared information provisioning engine 810 may also be operative to perform site specific searches of online sellers and/or general web searches using a web API, such as the Yahoo! Boss® API to recommend items to a user. The shared information provisioning engine 810 may also be operative to prioritize recommended items based on prioritization criteria. “Prioritization criteria” are factors that are used to order likely preferences of a product for a purchaser.

The social purchase engine 812 may facilitate searching for products based on inputs from the social input engine 808. The social purchase engine may interface with a purchase organization client (e.g., one of the purchase organization clients 116 or 124 in FIG. 1) and may implement one or more web search APIs.

The display engine 814 may be operative to display items that can be purchased. The display engine 814 may interface with a purchase organization client (e.g., one of the purchase organization clients 116 or 124 in FIG. 1).

In the example of FIG. 8, the document datastore 212 may store documents and emails that are to be parsed or have been parsed, saved parts of emails, and other documents relevant to the operation of the purchase organizer 130. The account datastore 214 may store user account information, email authorization and account information, order information, and other data for the purchase organizer 130. The parsing expressions datastore 216 may store parsing expressions.

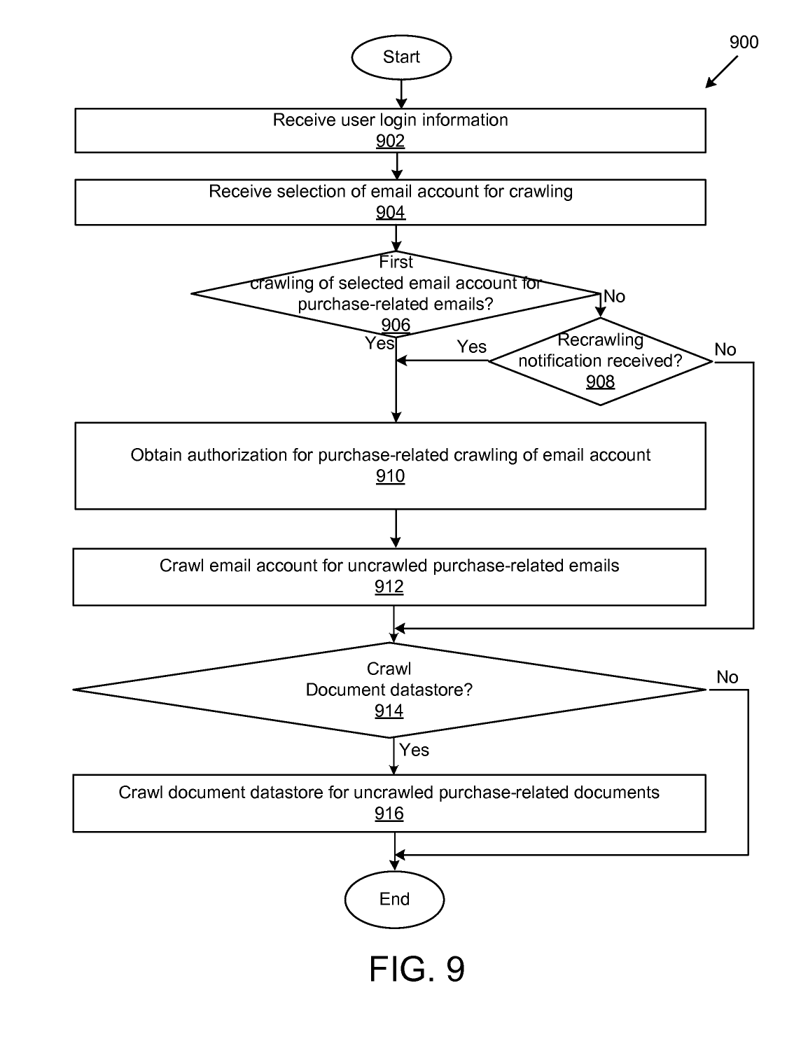

FIG. 9 shows an example of a method 900 for intelligently crawling purchase-related digital documents. The method 900 is discussed in conjunction with the purchase crawler 128 in FIG. 2. It is noted that the steps of the method 900 may be executed by structures other than the exemplary structures of FIG. 2. Further, in some embodiments, some of the steps of the method 900 may be omitted. In some embodiments, some of the steps of the method 900 may have substeps not shown herein.

In step 902, the user account management engine 202 receives login information. The user account management engine 202 may receive the information from the user through an input device (e.g., a keyboard) associated with the user. The login information may include a username and a password provided at the home page of a web portal. The login information may include a unique user identifier (e.g., a unique character string, the user's primary email address, a globally unique identifier (GUID)) that may be associated with the user in the closed retail network. In various embodiments, the login information may be based on a unique device identifier associated with a device associated with the user. For instance, the login information may be based on a property of the user's mobile phone, computer, network address, or other parameter. The user account management engine 202 may store or facilitate storage of the login information. For example, the user account management engine 202 may facilitate storage of the login information as a cookie on a datastore of a client device (e.g., one of the digital devices 104 and 106 in FIG. 1).

In some embodiments, the user account management engine 202 may prompt a user to create an account if the user account management engine 202 determines that the user has not yet created an account. The user account management engine 202 may request from a user a username, a password, and an associated contact such as an associated email address. The user account management engine 202 may also verify the contact information with a verification procedures, such as the sending of a verification email. The verification email may contain a trusted link that the user can employ to authenticate the contact information. The method 900 may proceed to step 904.

In step 904, the user account management engine 202 receives a selection of an email account for purchase-related crawling. The user account management engine 202 may provide the user with a list of email accounts associated with the user so that the user can select email accounts for crawling. A client (e.g., one of the purchase organization clients 116 and 124 in FIG. 1) may display the email account list to the user. The user account management engine 202 may initially populate the list with the verified email that serves as the user's primary contact information. The user account management engine 202 may also provide the user with the option of adding additional email addresses. In various embodiments, the user account management engine 202 may provide a plurality of fields corresponding to email account service providers. For instance, the user account management engine 202 may provide a field for Yahoo! Mail®, a field for Google Gmail®, a field for Microsoft Hotmail®, a field for Microsoft Outlook®, and fields for others. The user account management engine 202 may facilitate entry of one or more of the email addresses the user has provided. The user account management engine 202 may implement procedures to verify the authenticity of each of the provided emails. The user account management engine 202 may receive a selection of at least one of the email accounts for parsing. In some embodiments, a client (e.g., one of the purchase organization clients 116 and 124 in FIG. 1) provides the user selection to the user account management engine 202. The method 900 may then proceed to decision point 906.

At decision point 906, the user account management engine 202 determines whether it is the first crawling of the selected email account for purchase-related emails. To implement this determination, the user account management engine 202 may maintain, in the account datastore 214, a list of the email accounts of a user that have been previously crawled. Suppose, for instance, that a user has three email accounts, namely a Yahoo! Mail® account, a Google Gmail® account, and a Microsoft Hotmail® account. The user account management engine 202 may maintain an entry corresponding to the crawling history of each of the user's three accounts. If the entry in the account datastore 214 indicates that a specific email account has not been previously crawled, the user account management engine 202 may determine that it is the first crawling of the specific email account. The method 900 may then proceed to step 910. If, on the other hand, the entry in the account datastore 214 indicates that the specific email account has been crawled, the user account management engine 202 may determine that it is not the first crawling of the specific email account. The method 900 may then proceed to decision point 908.

At decision point 908, the update notification engine 206 determines whether a recrawling notification was received. The recrawling notification may be user-initiated. For instance, the user may instruct the update notification engine 206 to crawl an email account another time. The recrawling notification may also be dependent or correspond to a specific time or date (e.g., every hour or every day). The recrawling notification may correspond to the reception of a new email in one of the inboxes of the selected email account. The recrawling notification may also occur each time the user logs into the selected email account or into the closed retail network. During various times of the year like the holiday season, the recrawling notification may occur more often than other times of the year. Based on the recrawling notification, the update notification engine 206 may provide to other modules an instruction to crawl the selected email account. If the specific email account needs to be recrawled, the method 900 may proceed to step 910. If the specific email account does not need to be recrawled, the method 900 may proceed to decision point 914.

In step 910, the email account authorization engine 204 obtains authorization for purchase-related crawling of the specific email account. The email account authorization engine 204 may receive an indication from an email service provider that an authorized account holder has allowed purchase-related crawling of the specific email account. The authorization to the email account authorization engine 204 need not be the account holder's email username or password. Rather, in some embodiments, authorization may comprise token-based authorization. In some embodiments, for instance, the authorization may employ an open standard for token-based access, such as OAuth protocols. The token from the authorization protocols may specify the specific resources an account holder wishes to share with the email account authorization engine 204. The email account authorization engine 204 may use the open standard for token-based access with email service providers that support token-based authorization. The email account authorization engine 204 may employ licensed-server protocol based authorization, over which the email account authorization engine 204 receives a license from an email service provider to access specific resources. In various embodiments, however, the email account authorization engine 204 may also obtain an email account identifier and password. Once the email account authorization engine 204 obtains the authorization, the method 900 may proceed to step 912.

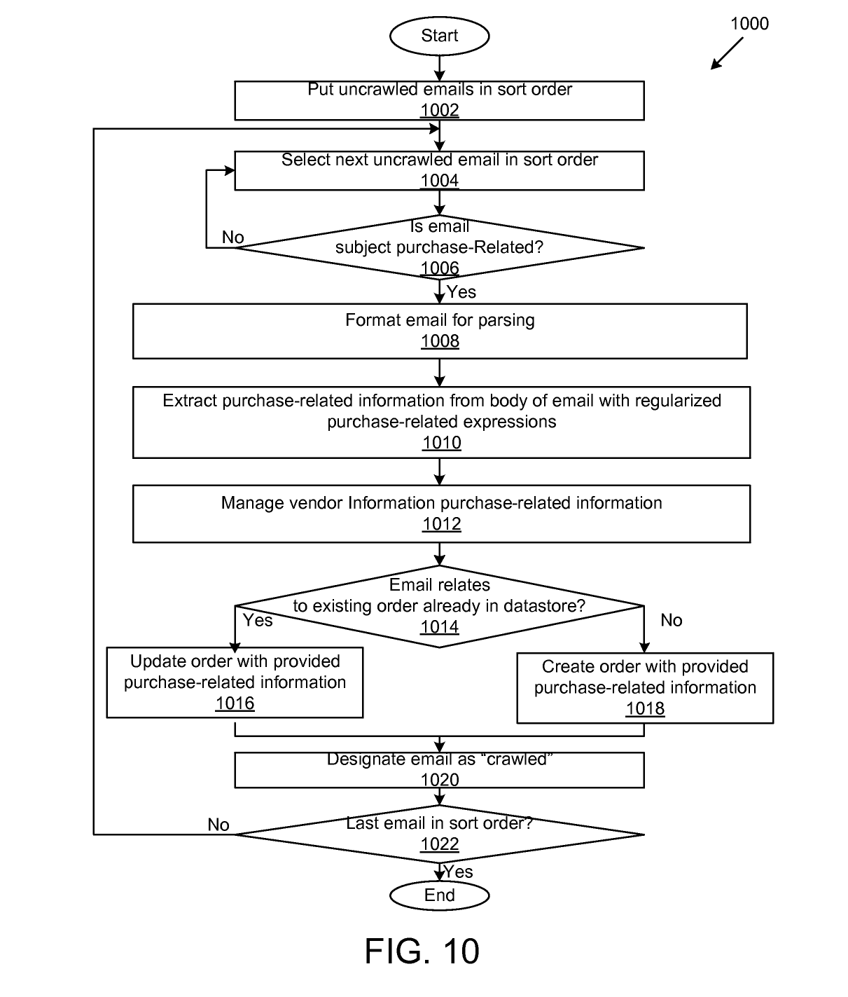

In step 912, the email crawler engine 208 crawls the selected email account(s) for uncrawled purchase-related emails. The email crawler engine 208 may intelligently extract purchase-related information from relevant parts of each uncrawled email in the selected email account(s). Relevant parts for crawling may include the email sender, subject, and body, among other parts. The email crawler engine 208 may employ a set of regularized purchase-related expressions to extract text that is to be identified as “purchase-related”. The email crawler engine 208 may base the regularized purchase-related expressions on a set of templates. The templates may be implemented on a per-vendor basis. FIG. 10 shows step 912 in greater detail. The method 900 may proceed to decision point 914.

At decision point 914, the document crawler engine 210 determines whether to crawl the document datastore 212 for uncrawled purchase-related documents. The document crawler engine 210 may base the decision to crawl the document datastore 212 on user input, a schedule, or a notification that files in the document datastore 212 have changed or been modified, for instance. If the document crawler engine 210 determines to crawl the document datastore 212 for uncrawled purchase-related documents, the method 900 may continue to step 916. If the document crawler engine 210 determines not to crawl the document datastore 212 for uncrawled purchase-related information, the method 900 may end.

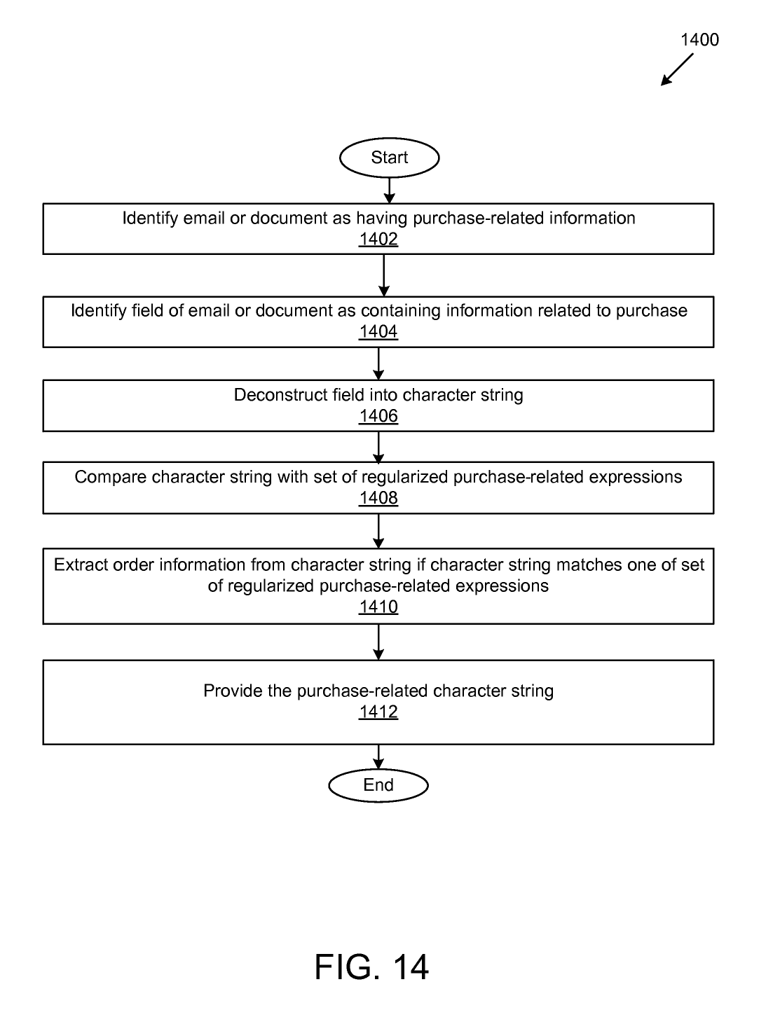

In step 916, the document crawler engine 210 crawls the document datastore 212 for purchase-related information. The document crawling engine 210 may intelligently extract purchase-related information from relevant parts of each uncrawled document in the document datastore 212. The document crawler engine 210 may employ a set of regularized purchase-related expressions to extract text that is to be identified as “purchase-related”. The document crawler engine 210 may base the regularized purchase-related expressions on a set of templates. The templates may be implemented on a per-vendor basis. FIG. 14 shows step 916 in greater detail. The method 900 may end.

It is noted that the order of the steps in FIG. 9 and other flowcharts herein serve to enable and provide written description to practice various embodiments. The steps in FIG. 9 and other flowcharts herein may be reordered without departing from the scope and substance of the inventive concepts described herein. For instance, although FIG. 9 shows the email account authorization being obtained in step 910, i.e., after decision points 906 and 908, it is noted that the email account authorization engine 204 may obtain email account authorization at any time, such as before decision points 908 and/or 906, or after step 912. Where the token-based or license-based access is used to obtain email account authorization, it is noted that the email account authorization engine 204 may store and/or retrieve tokens/licenses/identifiers in the account datastore 214 as desired for email crawling access.

Further, though FIG. 9 shows the email authorization being obtained in accordance with step 910, it is noted that various embodiments may import purchases to the purchase aggregation server 110 in other ways. For instance, the user account management engine 202 may assign each user of the purchase aggregation server 110 a proprietary email account. A purchaser may use the proprietary email account for the user's online and/or brick-and-mortar purchases. In these embodiments, the email crawler engine 208 may be configured to crawl the contents of the propriety email account. As another example, the user account management engine 202 may be configured to receive forwarded email addresses from one or more contact email accounts of a user. For instance, a user having a Yahoo! ® account and a Google Gmail® account may forward the user account management engine 202 all purchase-related emails from his or her Yahoo! ® and Gmail® accounts. In these embodiments, the user account management engine 202 may store copies of the forwarded emails in the document datastore 212. The email crawler engine 208 may be configured to crawl the forwarded emails in the document datastore 212.

FIG. 10 shows a flowchart of a method 1000 for intelligently extracting purchase-related information from emails. The method 1000 is discussed in conjunction with the purchase crawler 128 and the email crawler engine 208 in FIG. 3. It is noted that the steps of the method 1000 may be executed by structures other than the exemplary structures of FIG. 3. Further, in some embodiments, some of the steps of the method 1000 may be omitted. In various embodiments, some of the steps of the method 1000 may have substeps not shown herein. Also, the steps in the method 1000 may be reordered without departing from the scope and substance of the inventive concepts described herein.

In step 1002, the email selection engine 302 puts uncrawled emails in a sort order. The sort order of the emails may be chronological or reverse-chronological. The sort order may be by vendor. That is, the emails may be sorted by the specific sellers (e.g., online and/or brick-and-mortar sellrs) who sold the items in the emails. The emails may also be sorted by the entity that sent the emails (e.g., all emails from Amazon.com® or Apple® may be sorted together in the sort order). The sort order may be based on a vendor class, such as bookstores or clothing sellers. The sort order may also be based on purchaser class, the preferences of a user, or the preferences or identities of third-parties like advertisers. Once the email selection engine 302 has put the emails in the selected inbox in a sort order, the method 1000 may proceed to step 1004.

In step 1004, the email selection engine 302 selects the next uncrawled email in the sort order. The next uncrawled email is an email in the sort order immediately following an email that has been crawled. If the email selection engine 302 has determined that no emails in the sort order have been crawled, the next uncrawled email may be the first email in the sort order. To select an email, the email selection engine 302 may identify the email with a flag. In some embodiments, selecting an email may include caching the email or storing at least portions of the email in the document datastore 212. The email selection engine 302 may identify a seller (e.g., the online and/or brick-and-mortar sellers) associated with a selected email. In some embodiments, the seller may be identified from an evaluation of the origin address (i.e., the sender field) of the email. The email selection engine 302 may cache the email in the document datastore 212. Once the email selection engine 302 has selected an email for processing, the method 1000 may proceed to decision point 1006.

At decision point 1006, the email selection engine 302 determines whether the subject and/or attachments of the selected email is purchase-related. To perform this determination, the email selection engine 302 may apply a set of regularized purchase-related expressions configured to identify purchase keywords that typically appear in the subject line and/or attachments of a purchase-related email. The email selection engine 302 may use Internet Message Access Protocols (IMAP), a Web Application Programming Interface (API), Post Office Protocol (POP3), or other protocols to access the actual emails. For instance, the email selection engine 302 may search for keywords relating to an order such as “order confirmation”, or “receipt”. The email selection engine 302 may search for keywords related to shipping or carrier actions, such as “shipped”, “your order has shipped”, and other phrases.

The following examples show an example determination of whether an email subject is purchase-related. In various embodiments, the email selection engine 302 may use a set of regularized purchase-related expression to determine whether the subject of the email corresponds to an order subject. For example, the email selection engine 302 may implement the following expressions: “/Order\s+Confirmation/msi”; “/Your\s+order\s+has\s+been\s+received/msi”.

The email selection engine 302 may use a set of regularized purchase-related expressions to determine whether the subject of the email corresponds to a shipping subject. For instance, the email selection engine 302 may implement the following expressions: “Shipping\s+Confirmation/msi”; “/Your\s+order\s+has\s+been\s+shipped/msi”.

The email selection engine 302 may use a set of regularized purchase-related expressions to determine whether the subject of the email corresponds an updated order. For instance, the email selection engine 302 may implement the following expressions: “/Changes\s+ to\s+your\s+order/msi”; “/Your\s+order \s+has\s+been\s+returned/msi”; and “/Your\s+order\s+has\s+been\s+refunded/msi”.

The email selection engine 302 may also use a set of regularized purchase-related expression to determine whether the subject of the email indicates the email need not be parsed, as the email relates to promotional email or non purchase-related matters. For instance, the email selection engine 302 may implement the following expressions: “Free\s+Shipping/msi”; “/$10\s+off\s+your\s+next \s+purchase/msi”.

The email selection engine 302 may also determine whether the email subject includes the name of a known seller (e.g., online seller and/or brick-and-mortar seller). If the email selection engine 302 determines that the subject of the email is purchase-related, the method 1000 may proceed to step 1008. If the email selection engine 302 determines otherwise, the method 1000 may return to step 1004, where the email selection engine 302 selects the next uncrawled email in the sort order.

In the email selection engine 302 may also determine whether an email's attachments include keywords related to an order, whether the email's attachments correspond to shipping information, whether an email's attachments correspond to an updated order, whether an email's attachments indicate that the email need not be parsed, for instance. The email selection engine 302 may also determine whether an email is purchase-related based on portions of the email other than the subject and/or the attachments.

In step 1008, the email formatting engine 304 formats the email for parsing. The email formatting engine 304 may decompose the selected email into one or more constituent parts. Examples of constituent parts include a subject, indicators of attachments, the email body, and other parts. After decomposition, the email formatting engine 304 may organize the relevant constituent parts in a manner that facilities purchase-related parsing of the email. For instance, the email formatting engine 304 may identify the body of the email as a part of the email that is likely to contain purchase-related information. The email formatting engine 304 may strip portions of the email body that get in the way of efficient purchase-related parsing. The email formatting engine 304 may organize the email body into text sections, HTML sections, images, and attachments. The email formatting engine 304 may filter out portions of the email deemed irrelevant (e.g., embedded images and/or attachments) by storing only text and HTML sections in the document datastore 212. In various embodiments, the email formatting engine 304 may translate various portions of the email into a standardized character format such as the UTF-8 character format. The email formatting engine 304 may also strip out irrelevant HTML tags, keeping only the HTML tags that are useful for purchase-related parsing. Therefore, the email formatting engine 304 may strip out all tags other than text, anchors, and images. Once the email formatting engine 304 has ensured the email is in a format for purchase-related parsing, the method 1000 may continue to step 1010.

In step 1010, the email parsing engine 306 extracts purchase-related information from the relevant portions (e.g., the body) of the email using a set of regularized purchase-related expressions. As discussed, a regularized purchase-related expression is an expression that specifies a set of character strings likely to match purchase-related information contained in a block of text. Purchase-related information may include: a vendor name; an order identifier; and item information including a date of purchase, quantity of an item purchased, title of an item purchased, sub-title of an item purchased, and the price of an item purchased. Purchase-related information may also include time and venue information. For instance, for items likely to provide time and venue information (e.g., special events, travel, concerts, meetings, coordinated social gatherings, coordinated business gatherings), purchase-related information may include things such as a time and/or place of the items.

The email parsing engine 306 may apply parsing expressions from the parsing expressions datastore 216. The parsing expressions may be applied using a template. The template may be a vendor-specific template, i.e., a template designed to extract relevant purchase-related information from all emails from a particular vendor. To this end, the email parsing engine 306 may be configured to: identify a vendor based on text in the email body and determine whether there is a template for that vendor in the parsing expressions datastore 216. If there is no vendor template in the parsing expressions datastore 216 for that vendor, the email parsing engine 306 may be configured to create a vendor template using the extracted information. If there is a vendor template in the parsing expressions datastore 216 for that vendor, the email parsing engine 306 may be configured to update the vendor template using the extracted information.

The email parsing engine 306 may be configured to identify and extract purchase-related information contained on a single line of an email. A “line” of an email is a region of the email separated by two return characters.

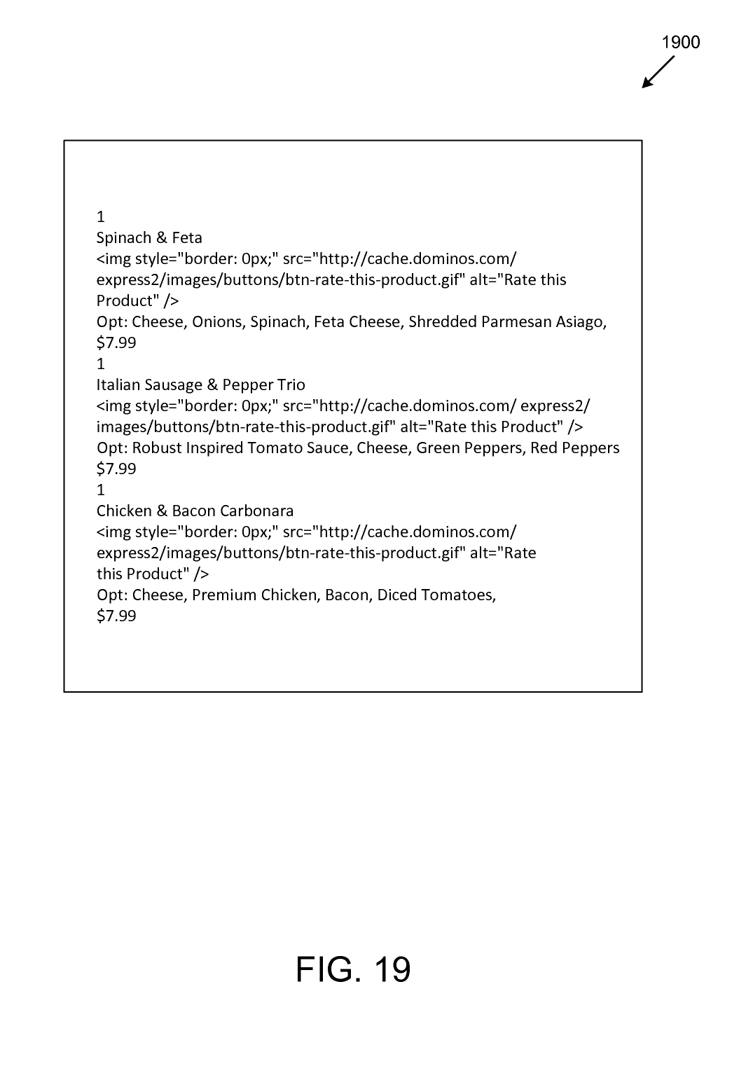

The email parsing engine 306 may be configured to identify and extract purchase-related information contained on a series of separate lines in the body of an email. FIG. 19 shows an example of a sample pizza order email 1900. The email 1900 contains five lines. It is noted that the display of the email 1900 may show more than five lines; however the email 1900 has five areas separated by return characters. The email 1900 shows pizza order from a pizza vendor, Dominos®. The email 1900 contains: in line 1, a number, which if parsed, may correspond to a quantity of purchased item; in line 2, the name of a pizza ordered which if parsed, may correspond to an item title; in line 3 HTML corresponding to irrelevant information; in line 4, things added to the pizza, which if parsed, may correspond to a subtitle of the item; and in line 5, the price paid for it, which if parsed, may correspond to a price. The price in line 5 may be repeated in the email multiple times, e.g., three times in the email 1900.

To isolate purchase-related information from the email 1900, the email parsing engine 306 may implement one or more regularized purchase-related expressions to intelligently match information in the email 1900 with items deemed important to characterize the order. For example, to capture the information on line 1 of the email 1900, the email parsing engine 306 may implement the code, “(\d+)\s*\n”. To capture the information in line 2, the email parsing engine 306 may implement the code, “([̂\n]+)\n”. To capture the information in line 3, the email parsing engine 306 may implement the code, “[̂\n]+\n”. To capture the information in line 4, the email parsing engine 306 may implement the code, “([̂\n]+)\n”. To capture the information in line 5, the email parsing engine 306 may implement the code, “\$([\d\,\.]+)”. The item pattern may be captured using the code, “/̂(\d+)\s*\n([̂\n]+)\n[̂\n]+\n([̂\n]+)\n\S([\d\,\.]+)/msi”. This sample script would reveal the following from the email 1900: the quantity is the number on line 1, the title is a character string on line 2, the sub-title is the character string on line 3, and the price is the number on line 5. The email parsing engine 306 may create a template, including a vendor-specific template using the information from this parsing.

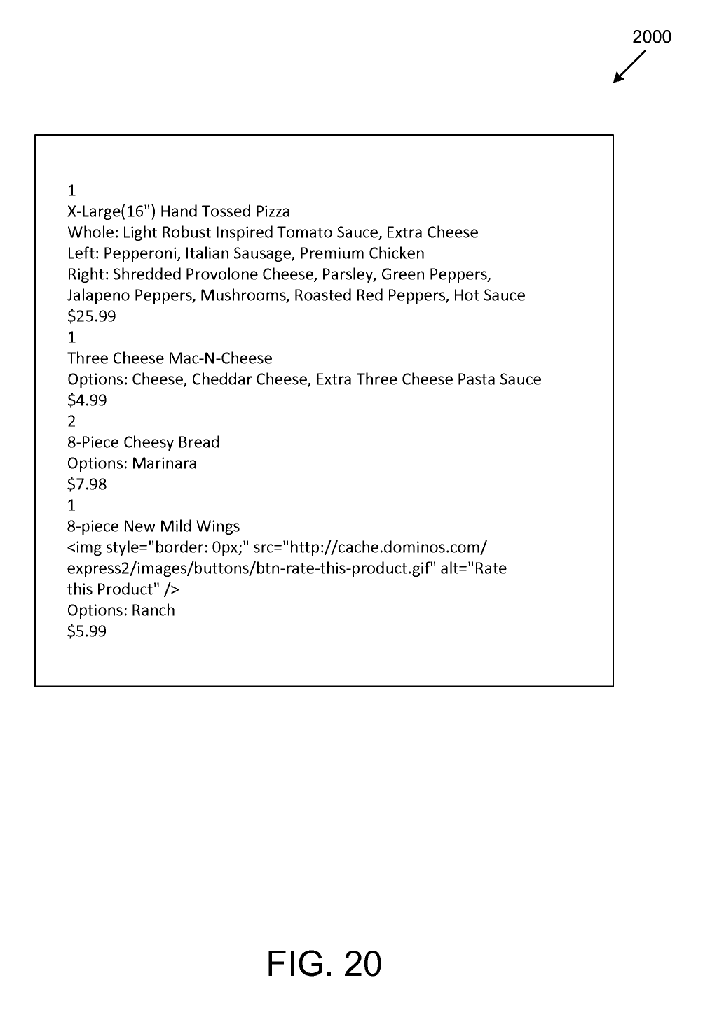

The email parsing engine 306 may be configured to identify and extract purchase-related information contained on a separate but variable number of lines contained in the body of the email. FIG. 20 shows an example of a sample pizza order email 2000. The email 2000 contains seven lines. It is noted that the display of the email 2000 may show more than seven lines; however the email 2000 has seven areas separated by return characters. The email 2000 shows pizza order from a pizza vendor, Dominos®. The email 2000 contains: in line 1, a number, which if parsed, may correspond to a quantity; in line 2, the name of pizza/appetizer, which if parsed, may correspond to an item title; in line 3 HTML, which if parsed may correspond to irrelevant information; in line 4, more information which if parsed, may correspond to irrelevant information; in line 5, more information, which if parsed, may correspond to irrelevant information; in line 6 more information, which if parsed, may correspond to irrelevant information; and in line 7, the price paid, which if parsed would correspond to the item total.

To isolate purchase-related information from the email 2000, the email parsing engine 306 may implement one or more regularized purchase-related expressions to intelligently match information in the email 2000 with items deemed important to characterize the order. To capture the information on line 1 of the email 2000, the email parsing engine 306 may implement the code, “(\d+)[̂\n]*\n”. To capture the information in line 2, the email parsing engine 306 may implement the code, “([̂\n]+)\n”. To capture the information in line 2, the email parsing engine 306 may implement the code, “(?:<img[̂>]+>[̂\n]*\n)?”. To capture information on lines 4-6, the email parsing engine may implement the code “((?:[”\$][̂\n]+\n)+)” to capture all contiguous lines that do not start with a “$” character. To capture the last line, the email parsing engine 306 may implement the code, “/̂(\d+)[̂\n]*\n([̂\n]+)\n(?:<img[̂>]+>[̂\n]*\ n)?((?:[̂\$][̂\n]+\n)+)\$([\d\,\.]+)/msi”. This sample script would reveal the following from the email 2000: the quantity is the number on line 1, the title is a character string on line 2, the sub-title is the character string on lines 4-6, and the price is the number on line 7. The email parsing engine 306 may create a template, including a vendor-specific template using the information from this parsing.

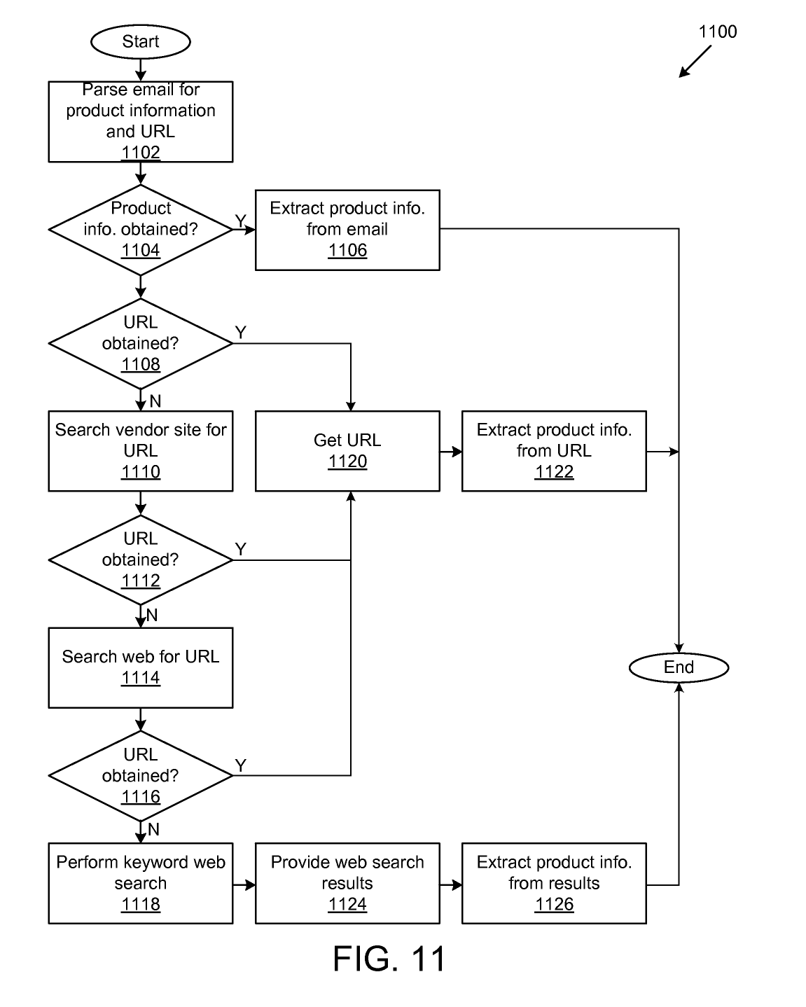

In various embodiments, the email parsing engine 306 may implement a set of regularized purchase-related expressions to identify a product URL or other information relating to the product. FIG. 11 shows this process in greater detail. Once the email parsing engine 306 has extracted the purchase related information from the body of the email, the method 1000 may continue to step 1012.

In step 1012, the vendor management engine 308 may manage relevant vendor information using the extracted purchase-related information. Managing vendor information may include crating or updating a vendor template in the parsing expressions datastore 216. The vendor management engine 308 may create a vendor template based on the extracted purchase-related information from the email. To create a vendor template, the vendor management engine 308 may create a vendor identifier. A vendor identifier is a set of fields that uniquely identifies a seller. A vendor identifier can include one or more of: a name, a domain, and a category. The vendor management engine 308 may also conduct, based on the extracted purchase-related information, a discovery of sample emails for the vendor based on other emails stored in the document datastore 212. The vendor management engine 308 may also implement sets of regularized purchase-related expressions for an image pattern associated with a given vendor and a SKU pattern associated with a given vendor. The method 1000 may proceed to decision point 1014.

At decision point 1014, the order management engine 310 may determine whether, based on the extracted purchase-related information, the email relates to an order already in the account datastore 214. The order management engine 310 may compare the order identifier obtained by the email parsing engine 306 with a set of orders in the account datastore 214. If the order identifier matches a stored identifier of one of the orders in the account datastore 214, the method 1000 may continue to step 1016. If the order identifier does not match a stored identifier of one of the orders in the account datastore 214, the method 1000 may continue to step 1018.

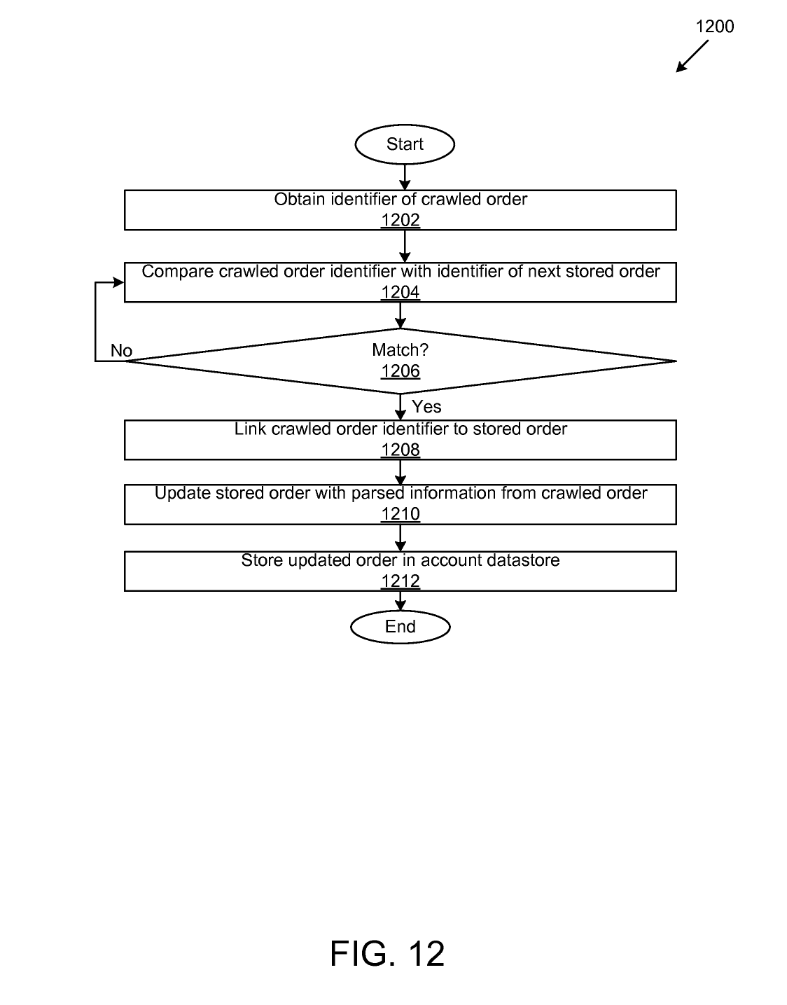

In step 1016, the order update engine 312 updates stored order information of an order stored in the account datastore 214. FIG. 12 shows the updating of an order in greater detail. The method 1000 may proceed to step 1020. In step 1018, the order management engine 310 creates an order in the account datastore 214 with the extracted purchase-related information. An order in the account datastore 214 may include information such as the vendor name, the order identifier, and item information. The method 1000 may proceed to step 1020. In step 1020, the email crawling status engine 314 designates the email as crawled. The email crawling status engine 314 may designate the email as crawled only if the email parsing engine 306 successfully extracted purchase-related information from the email. The designation may take the place of a flag associated with the email. Once the email crawling status engine 314 designates the email as crawled, the method 1000 may proceed to decision point 1022. At decision point 1022, the email selection engine 302 determines whether the crawled email is the last email in the sort order. If not, the method 1000 returns to step 1004. If so, the method 1000 ends.

As with other flowcharts discussed herein, it is noted that the steps in FIG. 10 may be reordered without departing from the scope and substance of the inventive concepts described herein. For instance, although FIG. 10 shows the vendor information being managed in step 1012, i.e., after some purchase-related information has been extracted from an email, it is noted that step 1012 may occur before any of decision point 1006, and steps 1008 and 1010, for instance.

FIG. 11 shows a flowchart of a method 1100 of intelligently extracting granular purchase-related information from emails. The method 1100 is discussed in conjunction with the purchase crawler 128 and the email parsing engine 306 in FIG. 4. It is noted that the steps of the method 1100 may be executed by structures other than the exemplary structures of FIG. 4. Further, in some embodiments, some of the steps of the method 1100 may be omitted. In some embodiments, some of the steps of the method 1100 may have substeps not shown herein. Also, the steps in the method 1100 may be reordered without departing from the scope and substance of the inventive concepts described herein.

In step 1102, the parsing expressions engine 402 parses an email for purchase-related information using a regularized set of purchase-related expressions from the parsing expressions datastore 216. The parsing expressions engine 402 may apply a set of regularized purchase-related expressions to extract purchase-related information from the email. The method 1100 continues to decision point 1104.

At decision point 1104, the purchase information validation engine 406 determines whether the parsing expressions engine 402 obtained sufficient purchase information from the email. Relevant item information may be the date of a purchase, quantity of an item purchased, title of the item purchased, subtitles associated with the item purchased, price of the purchased item, and the product URL of the item purchased. If the purchase information validation engine 406 determines that the parsing expressions engine 402 obtained sufficient purchase information from the email, the method 1100 continues to step 1106. If the purchase information validation engine 406 determines that the parsing expressions engine 402 did not obtain sufficient purchase information from the email, the method 1100 proceeds to decision point 1108.

In step 1106, the parsing expressions engine 402 extracts the product information from the email. The parsing expressions engine 402 may use regularized purchase-related expressions and/or vendor-based templates to extract the product information, as discussed in relation to FIG. 10. The method 1100 may terminate.

At decision point 1108, the purchase information validation engine 406 determines whether the parsing expressions engine 402 obtained the product URL from the email. The purchase information validation engine 406 may direct the parsing expressions engine 402 to apply a set of regularized purchase-related expressions to determine whether the email body contains a character string that corresponds to the product URL. An example of such an expression is a search for whether the character string “http://www.[vendor name] . . . ”. appears in the body of the email. If the purchase information validation engine 406 determines that the parsing expressions engine 402 did not obtain the product URL, the method 1100 proceeds to step 1110. On the other hand, if the purchase information validation engine 406 determines that the parsing expressions engine 402 obtained the product URL, the method 1100 proceeds to step 1120.

In step 1110, the search interface engine 404 searches the vendor site for the product URL. The search interface engine 404 may access a web API call in a site-specific manner, i.e., to direct a search of the vendor's website. The search interface engine 404 may supply keywords, such as the product name, the purchase price, and other keywords, to the web API for the site-specific search. The method 1100 may proceed to decision point 1112.

At decision point 1112, the purchase information validation engine 406 determines whether the search interface engine 404 obtained the product URL from the vendor site search. If so, the method 1100 proceeds to step 1120. If not, the method 1100 proceeds to step 1114. In step 1114, the search interface engine 404 searches the Internet for the product URL. The search interface engine 404 may access a web API call (e.g., Yahoo Boss) to search the internet for the product URL. The method 1100 may proceed to decision point 1116.

At decision point 1116, the purchase information validation engine 406 determines whether the search interface engine 404 obtained the product URL from the web search. If so, the method continues to step 1120. If not, the method continues to step 1118. In step 1118, the search interface engine 404 performs a keyword based web search for the product. In various embodiments, parameters of the web search can include items taken from the initial email (i.e., items that the parsing expressions engine 402 extracted from the email), as well as other keywords found likely to be related. The other keyword may be obtained from the parsing expressions datastore 216 and/or the document datastore 212. The method 1100 may continue to step 1124.

In step 1120, the search interface engine 404 gets the product URL. The search interface engine 404 directs crawling to the product URL. The method 1100 may continue to step 1122. In step 1122, the parsing expressions engine 402 extracts the product information from the URL. The parsing expressions engine 402 may use regularized purchase-related expressions and/or vendor-based templates to extract the product information. The method 1100 may terminate. In step 1124, the search interface engine 404 provides the web search results to the parsing expressions engine. The method 1100 may continue to step 1126. In step 1126, the parsing expressions engine 402 extracts the product information from the web search results. The parsing expressions engine 402 may use regularized purchase-related expressions and/or vendor-based templates to extract the product information. The purchase information validation engine 406 may cache any URLs obtained from the method 1000. The method 1100 may terminate.

FIG. 12 shows a flowchart of an example of a method 1200 for updating purchase-related orders, according to some embodiments. The method 1200 is discussed in conjunction with the purchase crawler 128 and the order update engine 312 in FIG. 5.

In step 1202, the order retrieval engine 502 obtains an identifier of a crawled order. An identifier of a crawled order is label of the identity of the crawled order. In some embodiments, the identifier may be an order name, an order number, or other label. The order identifier may be a vendor-specific identifier, that is, an identifier used by a specific seller to designate the crawled order. In various embodiments, the vendor identifier may be a store keeping unit (SKU) of the order. The order identifier may be associated with or retrieved from the URL of the order. The order retrieval engine 502 may provide the identifier of the crawled order to the order comparison engine 504. The method 1200 may proceed to step 1204.

In step 1204, the order comparison engine 504 may compare the identifier of the crawled identifier with one of a set of orders stored in the account datastore 214. The order comparison engine 504 may evaluate whether the identifier of the crawled order substantially matches an identifier of one of the orders stored in the account datastore 214. The method 1200 may proceed to decision point 1206.

At decision point 1206, the order comparison engine 504 determines whether the identifier of the crawled order matches the identifier of the stored order. The method 1200 may proceed to step 1208. In step 1208, the order link engine 506 links the crawled order identifier to the stored order. The order link engine 506 may maintain in the account datastore 214 a table of links to facilitate connections between the crawled identifier and the stored order. The method 1200 may proceed to step 1210.

In step 1210, the order link engine 506 updates the stored order in the account datastore 214 with parsed information from the crawled order. The order link engine 506 may update one or more of the vendor name, the order identifier, and item information. As discussed, item information may include the date of purchase, quantity of an item purchased, title of the item purchased, subtitles associated with the item purchased, price of the purchased item, and the product URL of the item purchased. The method 1200 may proceed to step 1212. In step 1212, the order storage engine 508 stores the updated order in the account datastore 214. The method 1200 may then terminate.

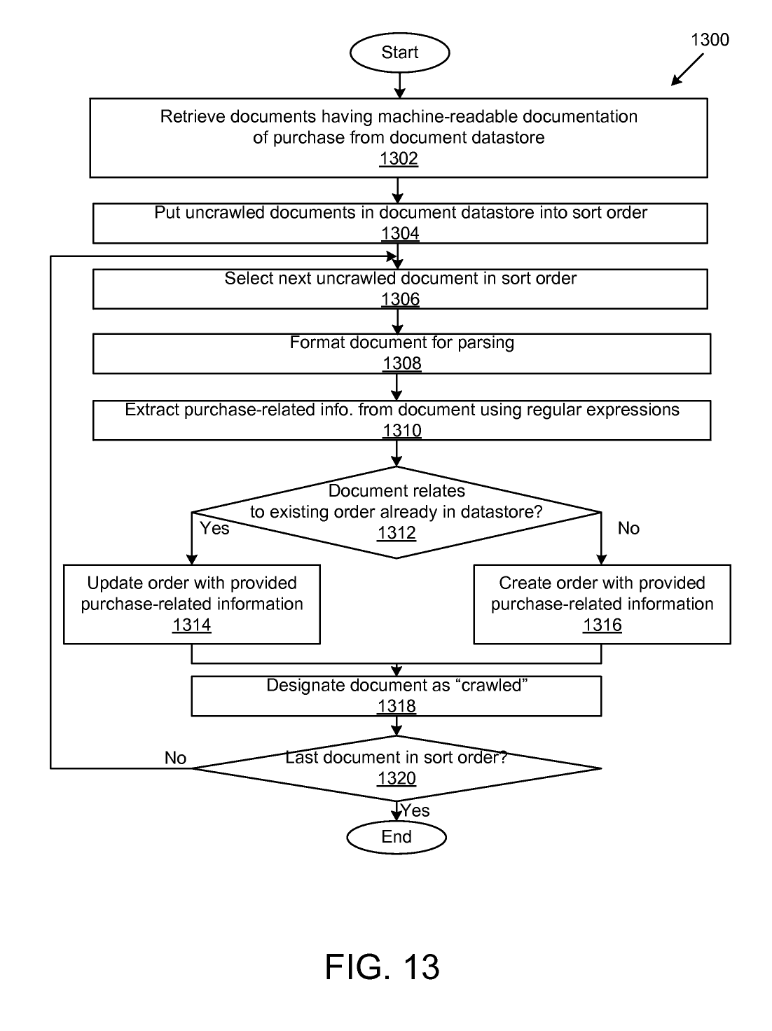

FIG. 13 shows a flowchart of an example of a method 1300 for intelligently extracting purchase-related information from documents, according to some embodiments. The method 1300 is discussed in conjunction with the purchase crawler 128 and the document crawler engine 210 in FIG. 6. It is noted that the steps of the method 1300 may be executed by structures other than the exemplary structures of FIG. 6. Further, in some embodiments, some of the steps of the method 1300 may be omitted. In some embodiments, some of the steps of the method 1300 may have substeps not shown herein. Also, the steps in the method 1300 may be reordered without departing from the scope and substance of the inventive concepts described herein.

In step 1302, the document selection engine 602 retrieves documents having a machine-readable documentation of a purchase from the document datastore 212. The document selection engine 602 may select one or more of the electronic representations of purchase documents in the document datastore 212. The document selection engine 602 may also select one or more of the photographical representations of purchased products stored in the document datastore 212. As discussed, any of the electronic representations of purchase documents or photographical representations of purchased products may have undergone optical character recognition (OCR) to render these representations machine-readable. In various embodiments, engines in the document selection engine 602 apply OCR or other techniques to render the representations machine-readable.

In step 1304, the document selection engine 602 puts uncrawled documents in the document datastore 212 into a sort order. The sort order of the documents may be chronological or reverse-chronological. The sort order may be by vendor. That is, the documents may be sorted by the specific sellers (e.g., the online seller and/or the brick-and-mortar seller) who sold the items in the documents. The sort order may be based on a vendor class, such as bookstores or clothing sellers. The sort order may also be based on purchaser class, the preferences of a user, or the preferences or identities of third-parties like advertisers. Once the document selection engine 602 has put the documents in the selected inbox in a sort order, the method 1300 may proceed to step 1306.

In step 1306, the document selection engine 602 selects the next uncrawled document in the sort order. The next uncrawled document is a document in the sort order immediately following a document that has been crawled. If no document has been crawled, the next uncrawled document is the first document in the sort order. The document selection engine 602 may select a specific document using a flag. The document selection engine 602 may cache or store portions of the selected document. Once the document selection engine 602 has selected a document for processing, the method 1300 may proceed to step 1308.

In step 1308, the document formatting engine 604 formats the selected document for parsing. The document formatting engine 604 may decompose the selected document into one or more constituent parts. Examples of constituent parts of an electronic representation of a purchase document include portions of the purchase document that appear to be a purchase receipt, and portions of the purchase document that do not appear to be a purchase receipt. Examples of constituent parts of photographical representations of purchased products include textual product titles and descriptions, photographs or images of the purchased product, and instructional or warning labels. For instance, the document formatting engine 604 may identify text on a photographic representation of a purchased product as likely to provide a title or description of the product. The document formatting engine may also identify an image on a photographic representation of a purchased product as likely to provide an image of the product. The document formatting engine 604 may organize the constituent portions of the representations of purchase documents and/or purchased products to facilitate efficient parsing. In various embodiments, the document formatting engine 604 may translate text on the representations into a standardized character format such as the UTF-8 character format. Once the document formatting engine 604 has ensured the selected document is in a format for purchase-related parsing, the method 1300 may proceed to step 1310.

In step 1310, the document parsing engine 606 extracts purchase-related information from the relevant portions (e.g., textual portions) of the selected document using a set of regularized purchase-related expressions. As discussed, a regularized purchase-related expression is an expression that specifies a set of character strings likely to match purchase-related information contained in a block of text. Purchase-related information may include: a vendor name; an order identifier; and item information including a date of purchase, quantity of an item purchased, title of an item purchased, sub-title of an item purchased, and the price of an item purchased.

The document parsing engine 606 may apply parsing expressions from the parsing expressions datastore 216. The parsing expressions may be applied using a template. The template may be a vendor-specific template, i.e., a template designed to extract relevant purchase-related information from all documents associated with a particular vendor. To this end, the document parsing engine 606 may be configured to: identify a vendor based on text in textual portions of the document and determine whether there is a template for that vendor in the parsing expressions datastore 216. If there is no vendor template in the parsing expressions datastore 216 for that vendor, the document parsing engine 606 may be configured to create a vendor template using the extracted information. If there is a vendor template in the parsing expressions datastore 216 for that vendor, the document parsing engine 606 may be configured to update the vendor template using the extracted information.

The document parsing engine 606 may employ techniques similar to the document parsing engine 606, discussed in the context of FIGS. 3 and 10. For instance, the document parsing engine 606 may be configured to identify and extract purchase-related information contained on a single line of textual portions of the selected document. The document parsing engine 606 may be configured to identify and extract purchase-related information contained on a series of separate lines in textual portions of the selected document. The document parsing engine 606 may be configured to identify and extract purchase-related information contained on a separate but variable number of lines contained in textual portions of the selected document. In some embodiments, the document parsing engine 606 may implement a set of regularized purchase-related expressions to identify a product URL or other information relating to the product. The document parsing engine 606 may also manage vendor information. The method 1300 may proceed to decision point 1312.

At decision point 1312, the order management engine 608 may determine whether, based on the extracted purchase-related information, the selected document relates to an order already in the account datastore 214. The order management engine 608 may compare the order identifier obtained by the document parsing engine 606 with a set of orders in the account datastore 214. If the order identifier matches a stored identifier of one of the orders in the account datastore 214, the method 1300 may continue to step 1314. If the order identifier does not match a stored identifier of one of the orders in the account datastore 214, the method 1300 may continue to step 1316.

In step 1314, the order update engine 610 updates stored order information of an order stored in the account datastore 214. The order update engine 610 may use a method similar to the method 1200 in FIG. 12. The method 1300 may proceed to step 1318.

In step 1316, the order management engine 608 creates an order in the account datastore 214 with the extracted purchase-related information. An order in the account datastore 214 may include information such as the vendor name, the order identifier, and item information. The method 1300 may proceed to step 1318. In step 1318, the document marking engine 612 designates the document as crawled. The document marking engine 612 may designate the selected document as crawled only if the document parsing engine 606 successfully extracted purchase-related information from the selected document. The designation may take the place of a flag associated with the selected document. Once the document marking engine 612 designates the selected document as crawled, the method 1300 may proceed to decision point 1320. At decision point 1320, the document selection engine 602 determines whether the crawled document is the last document in the sort order. If not, the method 1300 returns to step 1306. If so, the method 1300 ends. As with other flowcharts discussed herein, it is noted that the steps in FIG. 13 may be reordered without departing from the scope and substance of the inventive concepts described herein. For instance, although FIG. 13 shows the vendor information being managed in step 1308, i.e., after some purchase-related information has been extracted from a document, it is noted that vendor management may occur before step 1304, for instance.

FIG. 14 shows a flowchart of an example of a method 1400 for parsing purchase-related digital documents, according to some embodiments. The method 1400 is discussed in conjunction with the email crawler engine 208 in FIG. 3 and the document crawler engine 210 in FIG. 6. It is noted that the steps of the method 1400 may be executed by structures other than the exemplary structures of FIGS. 3 and 6. Further, in some embodiments, some of the steps of the method 1400 may be omitted. In some embodiments, some of the steps of the method 1400 may have substeps not shown herein. Also, the steps in the method 1400 may be reordered without departing from the scope and substance of the inventive concepts described herein.

Step 1402 comprises identifying an email or document as having purchase-related information. The email selection engine 302 may be configured to identify an email as a purchase-related document. In various embodiments, the document selection engine 602 may be configured to identify an email as a purchase-related document. The method 1400 may proceed to step 1404.

Step 1404 comprises identifying a field of the email or document as containing information related to a purchase. The email formatting engine 304 may be configured to identify an email field as containing purchase-related information. In some embodiments, the document formatting engine 604 may be configured to identify a field of a document as containing purchase-related information. The method 1400 may proceed to step 1406.

Step 1406 comprises deconstructing the field into a character string. The email formatting engine 304 may be configured to deconstruct the identified email field into a character string. In various embodiments, the document formatting engine 604 may be configured to deconstruct the identified field of the document into a character string. The method 1400 may proceed to step 1408.

Step 1408 comprises comparing the character string with a set of regularized purchase-related expressions. In some embodiments, the email parsing engine 306 or the document parsing engine 606 may be configured to compare the character string with a set of regularized purchase-related expressions. The method 1400 may proceed to step 1410.

Step 1410 comprises extracting order information from the character string if the character string matches one of the set of regularized purchase-related expressions. In various embodiments, the email parsing engine 306 or the document parsing engine 606 may be configured to extract order information from the character string if the character string matches one of the set of regularized purchase-related expressions. The method 1400 may proceed to step 1412. Step 1412 comprises providing the purchase-related character string. In some embodiments, the email parsing engine 306 or the document parsing engine 606 may be configured to provide the purchase-related character string. The method 1400 may terminate.

FIG. 15 shows a flowchart of an example of a method 1500 for organizing crawled purchase-related information, according to some embodiments. The method 1500 is discussed in conjunction with the purchase aggregation server 110 and the purchase organizer 130 in FIG. 7. It is noted that the steps of the method 1500 may be executed by structures other than the exemplary structures of FIG. 7. Further, in some embodiments, some of the steps of the method 1500 may be omitted. In various embodiments, some of the steps of the method 1500 may have substeps not shown herein. Also, the steps in the method 1500 may be reordered without departing from the scope and substance of the inventive concepts described herein.

In step 1502, the order retrieval engine 702 accesses the account datastore 214 for order information from crawled emails or documents. The order retrieval engine 702 may authenticate access to the account datastore 214 using a set of credentials, such as an identifier and an account password. The identifier may comprise a username or may comprise an identifier of a computer process associated with the order retrieval engine 702. The access of the order retrieval engine 702 to the account datastore 214 may be secure or encrypted. In some embodiments, orders information sought from the account datastore 214 may be for information from crawled emails or documents. The method 1500 proceeds to step 1504.

In step 1504, the order retrieval engine 702 retrieves order information for a set of orders. In various embodiments, the order retrieval engine 702 may retrieve, for each order in a set of orders, a title, a subtitle, a SKU, a URL, a price, a quantity, and other information. The method 1500 proceeds to step 1506.

In step 1506, the order sorting engine 704 groups the set of orders by item identifier based on the order information. The order sorting engine 704 may base the groups on a parameter of the order information. The groups may be based on items having a same or similar title, items sharing SKUs, items having similar prices, items purchased in similar quantities, and other parameters. The grouping may also be based on a vendor, vendor class, or characteristic of the vendor like the vendor's industry. The grouping may be based on characteristics of the customers making specific orders in the set of orders. For instance, the grouping may be based on demographic information or other information relating to a customer. The method may proceed to step 1508.

In step 1508, the sales information retrieval engine 706 identifies cross-vendor information for each item in the set of orders based on the grouping. “Cross-vendor information” for an item is information such as descriptive information attributed to an item by one or more vendors. For instance, the sales information retrieval engine 706 may obtain the price that different vendors have sold a given item at. The sales information retrieval engine 706 may also obtain various descriptions different vendors have given to a specific item to facilitate a fuller description of the item. The sales information retrieval engine 706 may obtain various pictures different vendors have provided for a given item. To obtain cross-vendor information, the sales information retrieval engine 706 may run structured queries on information in the account datastore 214 or may use web API calls (e.g., Yahoo! Boss® API calls). The method 1500 may proceed to step 1510.

In step 1510, the display engine 708 provides cross-vendor sales information for display. The display engine 708 facilitate the display of the various prices, descriptions, photographs, and other information different vendors have assigned to a specific item that has been purchased. Advantageously, the purchase organizer 130 allows the presentation of items that have actually been sold without gaining any information from the sellers, who have incentives to withhold purchase information as confidential or distort actual purchase prices.

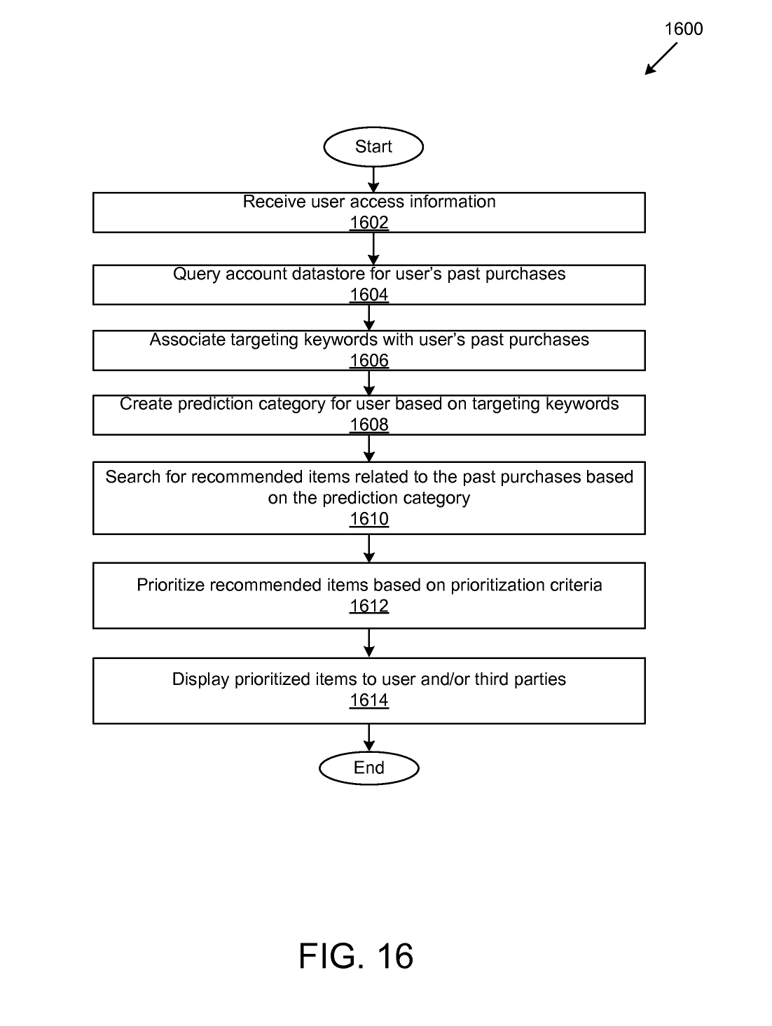

FIG. 16 shows a flowchart of an example of a method 1600 for prioritizing crawled purchase-related information, according to some embodiments. The method 1600 is discussed in conjunction with the purchase aggregation server 110 and the purchase portal 132 in FIG. 8. It is noted that the steps of the method 1600 may be executed by structures other than the exemplary structures of FIG. 8. Further, in some embodiments, some of the steps of the method 1600 may be omitted. In some embodiments, some of the steps of the method 1600 may have substeps not shown herein. Also, the steps in the method 1600 may be reordered without departing from the scope and substance of the inventive concepts described herein.

In step 1602, the order retrieval engine 802 receives user access information. User access information may include login information a unique identifier that labels the user in the system. The order retrieval engine 802 may retrieve the user access information from the account datastore 214. The flowchart 1600 may continue to step 1604.

In step 1604, the order retrieval engine 802 queries the account datastore 214 for the user's past purchases. In various embodiments, the order retrieval engine 802 may request all purchases associated with the user. The order retrieval engine 802 may also apply filters to the query. For instance, the order retrieval engine 802 may request all items a user has purchased within a given period of time. The order retrieval engine 802 may request all items a user has purchased from a seller, a group of sellers, or a class of sellers. As discussed, the seller, group of sellers, and/or class of sellers may relate to online and/or brick-and-mortar sellers. The order retrieval engine 802 may query the account datastore 214 for all items purchased within a given geographical area or shipped using common or similar methods. The specific filters applied may depend on attributes of the user or attributes of an intelligent targeting scheme. An intelligent targeting scheme is a method of targeting items toward a user so that the user can be presented with the option of purchasing those items. In some embodiments, the order retrieval engine 802 may query the account datastore 214 for a list of items that meet an intelligent targeting scheme. For instance, if a marketing campaign seeks to market sports-related products, the order retrieval engine 802 may query the account datastore 214 for all the sports-related purchases a given user has made. The order retrieval engine 802 may also query the account datastore 214 for purchases from industries related to sports industries, such as outdoor gear, outdoor entertainment, and books relating to sports and/or outdoor lifestyles. Once the order retrieval engine 802 queries the account datastore 214 for the user's past purchases, the method 1600 may proceed to step 1606.

In step 1606, the user purchase correlation engine 804 associates targeting keywords with the user's past purchases. Specific targeting keywords for a given context or product may come from third-parties such as advertisers or parties wishing to monetize the sale of items. Specific targeting keywords may also come from sellers (e.g., online sellers and/or brick-and-mortar sellers) wishing to sell items or purchasers who wish to direct the flow of purchases for a product, class of products, or industry. The flowchart 1600 may proceed to step 1608.

In step 1608, the user purchase correlation engine 804 creates a prediction category for the user based on the targeting keywords. The user purchase correlation engine 804 may base the prediction category on the targeting keywords. The user purchase correlation engine 804 may also base the prediction category on other factors, such as the time of the year, characteristics of the seller, and characteristics of the buyer. For instance, if the targeting keywords suggest providing product recommendations about sports and the user purchase correlation engine 804 determines that it is September, the prediction category may involve a category related to football or basketball, which may or may not be correlated with interests in fall and sports. If the targeting keywords suggest providing product recommendations about sports and the user purchase correlation engine 804 determines that it is May, the prediction category may involve a category related to baseball or summertime camping, which may or may not be correlated with interests in springtime and sports. Once the prediction category has been created for the user, the method 1600 may continue to step 1610.

In step 1610, the shared information provisioning engine 810 searches for recommended items based on the prediction category. To search for items, the shared information provisioning engine 810 may employ site specific searches of the websites of online sellers, brick-and-mortar sellers, and/or general web searches using a web API. Based on the prediction category, the shared information provisioning engine 810 may create search keywords to search through websites of sellers for recommended products and items. For instance, if the user purchase correlation engine 804 created a prediction category of summertime camping, the shared information provisioning engine 810 would search for tents, outdoor stoves, summertime sleeping bags, and other items related to summertime camping. The shared information provisioning engine 810 may also retrieve the results. The method 1600 may proceed to step 1610.

In step 1612, the shared information provisioning engine 810 prioritizes the recommended items based on prioritization criteria. The prioritization criteria may include characteristics of the user. For instance, if the shared information provisioning engine 810 returned a search for tents, outdoor stoves, summertime sleeping bags, and other information, and prioritization criteria indicated that a specific user was most likely to spend about $50, the shared information provisioning engine 810 may prioritize the results based on the user's price point. The method 1600 may proceed to step 1614.

In step 1614, the display engine 814 displays the prioritized items to the user and/or third parties. The display engine 814 may display a list of items for access in a purchase organization client (e.g., one of the purchase organization clients 116 or 124 in FIG. 1). The display engine 814 may provide the prioritized items to third-parties such as advertisers. The flowchart 1600 may then terminate.

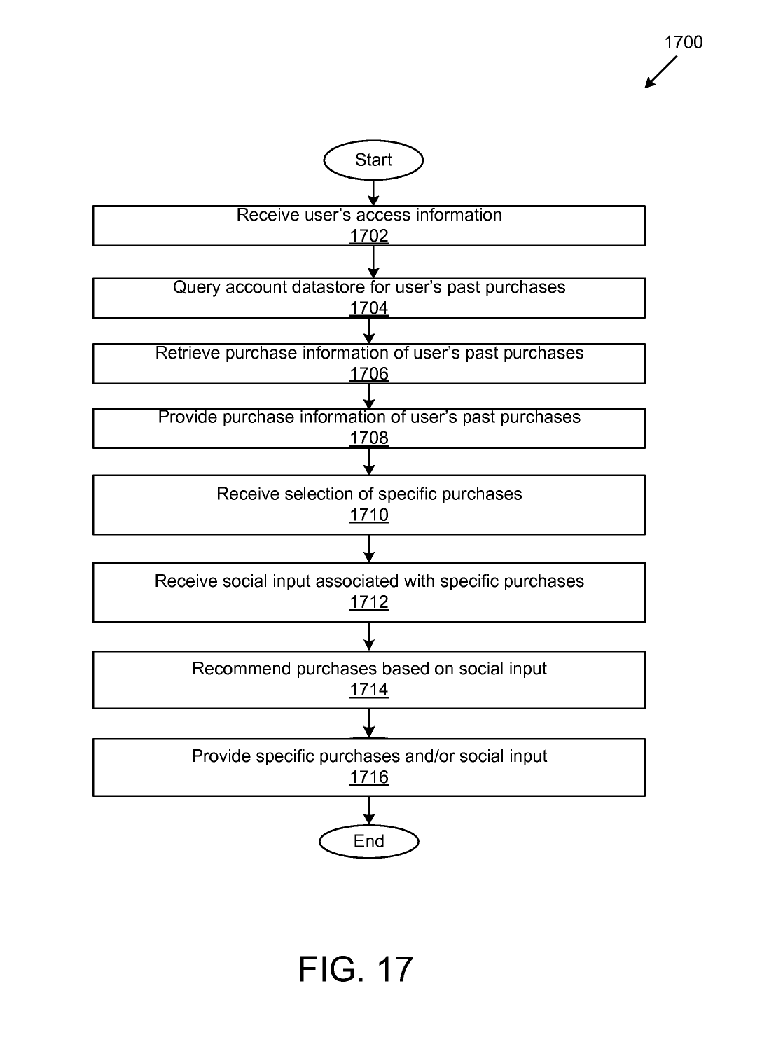

FIG. 17 shows a flowchart of an example of a method 1700 for facilitating sharing of crawled purchase-related information, according to some embodiments. The method 1700 is discussed in conjunction with the purchase aggregation server 110 and the purchase portal 132 in FIG. 8. It is noted that the steps of the method 1700 may be executed by structures other than the exemplary structures of FIG. 8. Further, in some embodiments, some of the steps of the method 1700 may be omitted. In various embodiments, some of the steps of the method 1700 may have substeps not shown herein. Also, the steps in the method 1700 may be reordered without departing from the scope and substance of the inventive concepts described herein.

In step 1702, the order retrieval engine 802 receives user access information. User access information may include login information a unique identifier that labels the user in the system. The order retrieval engine 802 may retrieve the user access information from the account datastore 214. The method 1700 may continue to step 1704.

In step 1704, the order retrieval engine 802 queries the account datastore 214 for the user's past purchases. In various embodiments, the order retrieval engine 802 may request all purchases associated with the user. The order retrieval engine 802 may also apply filters to the query. Examples of filters include: all items a user has purchased within a given period of time; all items a user has purchased from a seller, a group of sellers, or a class of sellers; all items purchased within a given geographical area or shipped using common or similar methods. The specific filters applied may depend on attributes of the user or attributes of an intelligent targeting scheme. An intelligent targeting scheme is a method of targeting items toward a user so that the user can be presented with the option of purchasing those items. In some embodiments, the order retrieval engine 802 may query the account datastore 214 for a list of items that meet an intelligent targeting scheme. The method 1700 may proceed to step 1706.

In step 1706, the user purchase correlation engine 804 retrieves the purchase information of the user's past purchases from the account datastore 214. The user purchase correlation engine 804 may obtain the information of the specific purchases based on the results of the queries of the order retrieval engine 802. The method 1700 may proceed to step 1708.

In step 1708, the display engine 814 provides the purchase information of the user's past retail purchases. The display engine 814 may provide a purchase organization client (e.g., one of the purchase organization clients 116 and 124) with the purchase information of the user's past retail purchases. The method 1700 may proceed to step 1710.

In step 1710, the purchase selection engine 806 receives a selection of specific retail purchases. The selection may come from one of a purchase organization client (e.g., one of the purchase organization clients 116 and 124). The selection may correspond to a user wishing to indicate that one or more of the user's purchases are to be designated for further processing. The method 1700 may continue to step 1712.

In step 1712, the social input engine 808 may receive social input associated with the specific retail purchases. The social input may come from the user or from one or more other members of the user's community. For instance, in various embodiments, the social input engine 808 may receive the social input from the user, the user's friends from social networks, people who share common interests with the user, companies who wish to monetize the user's purchase or proposed purchase, and others. The social input may be a proprietary social input (e.g., an invitation input, a polling input, a recommendation input, or other form of input) or a third-party social input (e.g., information from a person's Facebook® or Pinterest® pages. The method 1700 may continue to step 1714.

In step 1714, the social purchase engine 812 recommends purchases based on the social input. For example, the social purchase engine 812 may conduct a site specific or general web search based on information from proprietary social inputs (e.g., invitation inputs, polling inputs, recommendation inputs, and other inputs) or third-party social inputs (e.g., information from a person's Facebook® or Pinterest® pages. The method 1700 may continue to step 1716.

In step 1716, the display engine 814 may provide the suggested purchases and/or the social input. In various embodiments, the display engine 814 may provide the specific suggested purchases and/or the social input to the user or to other members of the community. The method 1700 may terminate.

FIG. 18 depicts a digital device 1800, according to some embodiments. The digital device 1800 comprises a processor 1802, a memory system 1804, a storage system 1806, a communication network interface 1808, an I/O interface 1810, and a display interface 1812 communicatively coupled to a bus 1814. The processor 1802 may be configured to execute executable instructions (e.g., programs). The processor 1802 comprises circuitry or any processor capable of processing the executable instructions.

The memory system 1804 is any memory configured to store data. Some examples of the memory system 1804 are storage devices, such as RAM or ROM. The memory system 1804 may comprise the RAM cache. In some embodiments, data is stored within the memory system 1804. The data within the memory system 1804 may be cleared or ultimately transferred to the storage system 1806.

The storage system 1806 is any storage configured to retrieve and store data. Some examples of the storage system 1806 are flash drives, hard drives, optical drives, and/or magnetic tape. The digital device 1800 includes a memory system 1804 in the form of RAM and a storage system 1806 in the form of flash data. Both the memory system 1804 and the storage system 1806 comprise computer readable media which may store instructions or programs that are executable by a computer processor including the processor 1802.

The communication network interface (com. network interface) 1808 may be coupled to a data network (e.g., bus 1814) via the link 1816. The communication network interface 1808 may support communication over an Ethernet connection, a serial connection, a parallel connection, or an ATA connection, for example. The communication network interface 1808 may also support wireless communication (e.g., 1802.8 a/b/g/n, WiMAX). It will be apparent to those skilled in the art that the communication network interface 1808 may support many wired and wireless standards.

The optional input/output (I/O) interface 1810 is any device that receives input from the user and output data. The display interface 1812 is any device that may be configured to output graphics and data to a display. In one example, the display interface 1812 is a graphics adapter.

It will be appreciated by those skilled in the art that the hardware elements of the digital device 1800 are not limited to those depicted in FIG. 18. A digital device 1800 may comprise more or less hardware elements than those depicted. Further, hardware elements may share functionality and still be within various embodiments described herein. In one example, encoding and/or decoding may be performed by the processor 1802 and/or a co-processor located on a GPU.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

I claim:

1. A method, comprising:
identifying a portion of a digital document as containing information related to an order;
deconstructing the portion into a character string;
comparing the character string with a set of regularized purchase-related expressions, thereby parsing the character string;
extracting purchase-related information from the character string if the character string matches one of the set of regularized purchase-related expressions; and
providing extracted purchased-related information.

2. The method of claim 1, wherein the digital document comprises one or more of an email and a machine-readable representation of a physical purchase document.

3. The method of claim 1, further comprising using the extracted purchase-related information to update a preexisting order in an account datastore.

4. The method of claim 1, wherein the digital document comprises a digital shipping document associated with the order.

5. The method of claim 1, further comprising:
determining whether the extracted purchase-related information provides sufficient purchase information of the order; and
facilitating a search for more information if the extracted purchase-related information does not provide the sufficient purchase information of the order.

6. The method of claim 5, wherein the sufficient purchase information comprises one or more of: a title, a subtitle, an image, a stock-keeping unit (SKU) and a uniform resource locator (URL) associated with the order.

7. The method of claim 5, wherein facilitating the search for the more information comprises:
comparing the character string with a uniform resource locator (URL) purchase-related expression configured to extract a URL of the order from the character string;
performing a vendor-site search for the URL if the character string does not match the URL purchase-related expression; and
performing a web search for the URL if the vendor-site search does not match the URL purchase-related expression.

8. The method of claim 1, further comprising verifying that the portion is in a standardized character format before deconstructing the portion into the character string.

9. The method of claim 1, wherein identifying the portion of the digital document comprises:
authenticating access to an account associated with the digital document;
accessing the account based on the authentication.

10. The method of claim 1, wherein identifying the digital document as a purchase-related document comprises identifying a vendor name in the digital document.

11. The method of claim 1, wherein the portion comprises a body field of an email.

12. The method of claim 1, wherein deconstructing the portion into the character string comprises stripping hypertext markup language (HTML) tags from the portion and identifying unstripped portions of the portion as containing the purchase-related information.

13. The method of claim 1, wherein the set of regularized purchase-related expressions is implemented using an expression template.

14. The method of claim 1, wherein the set of regularized purchase-related expressions comprises a set of vendor-specific purchase-related expressions configured to facilitate extracting an identity of a vendor associated with the order.

15. A system, comprising:
a parsing expressions datastore storing a set of regularized purchase-related expressions;
a datastore configured to store information of an order and a digital document;
a selection engine configured to select a digital document from the datastore;
a decomposition engine configured to identify a portion of the digital document as containing information related to the order;
a formatting engine configured to deconstruct the portion into a character string; and
a parsing engine configured to:
compare the character string with each of the set of regularized purchase-related expressions;
extract purchaser-related information from the character string if the character string matches a condition of one of the set of regularized purchase-related expressions; and
provide the extracted purchase-related information to the datastore.

16. The system of claim 15, wherein the digital document comprises one or more of an email and a machine-readable representation of a physical purchase document.

17. The system of claim 15, further comprising an order update engine configured to use the extracted purchase-related information to update a preexisting order in the datastore.

18. The system of claim 17, wherein the digital document comprises a shipping document associated with the order.

19. The system of claim 15, further comprising:
a purchase information validation engine configured to determine whether the extracted purchase-related information provides sufficient purchase information of the order; and
a search interface engine configured to facilitate a search for more information if the extracted purchase-related information does not provide the sufficient purchase information of the order.

20. The system of claim 19, wherein the sufficient purchase information comprises one or more of: a title, a subtitle, an image, a stock-keeping unit (SKU) and a uniform resource locator (URL) associated with the order.

21. The system of claim 19, wherein the search interface engine is configured to:
compare the character string with a uniform resource locator (URL) purchase-related expression configured to extract a URL of the order from the character string;
perform a vendor-site search for the URL if the character string does not match the URL purchase-related expression; and
perform a web search for the URL if the vendor-site search does not match the URL purchase-related expression.

22. The system of claim 15, wherein the formatting engine is configured to verify that the portion is in a standardized character format before deconstructing the portion into the character string.

23. The system of claim 15, further comprising an authentication engine configured to:
authenticate access to an account associated with the digital document; and
access the account based on the authentication.

24. The system of claim 15, wherein the decomposition engine is configured to identify a vendor name in the portion of the digital document.

25. The system of claim 15, wherein the portion comprises a body field of an email.

26. The system of claim 15, wherein the formatting engine is configured to deconstruct the portion into the character string by stripping hypertext markup language (HTML) tags from the portion and identifying unstripped portions of the portion as containing the purchase-related information.

27. The system of claim 15, wherein the set of regularized purchase-related expressions is implemented using an expression datastore.

28. The system of claim 15, wherein the set of regularized purchase-related expressions comprises a set of vendor-specific purchase-related expressions configured to facilitate extracting an identity of a vendor associated with the order.
